(19) United States
(12) Patent Application Publication
(10) Pub. No.: US 2008/0100909 A1
(43) Pub. Date: May 1, 2008

(54) Optical element, liquid immersion exposure apparatus, liquid immersion exposure method, and method for producing microdevice

(75) Inventor: Takeshi Tsuda, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 11/898,332

(22) Filed: Sep. 11, 2007

Related U.S. Application Data
(60) Provisional application No. 60/863,468, filed on Oct. 30, 2006.

(51) Int. Cl. G02B 13/14

(52) U.S. Cl. 359/355

(57) ABSTRACT

An optical element used such that at least one surface thereof is in contact with a liquid in a liquid immersion exposure apparatus in which a substrate is exposed by exposure light illuminated on the substrate via the liquid with a refraction index in a range between 1.60 and 1.66 to the light with a wavelength of 193 nm, comprising:
a base material with a refraction index in a range between 2.10 and 2.30 to the light with a wavelength of 193 nm; and
a first antireflection film formed on the contact surface between the base material and the liquid,
wherein the first antireflection film includes a first antireflection layer with a refraction index in a range between 1.80 and 2.02 to the light with a wavelength of 193 nm and an optical film thickness in a range between 0.25λ and 0.42λ to the wavelength λ of the exposure light,
a second antireflection layer with a refraction index in a range between 1.65 and 1.77 to the light with a wavelength of 193 nm and an optical film thickness in a range between 0.10λ and 0.45λ to the wavelength λ of the exposure light, and
the first antireflection layer and the second antireflection layer are sequentially laminated in an order from the base material side.

### BACKGROUND OF THE INVENTION

1. Field of the Invention

The present invention relates to an optical element used in a liquid immersion exposure apparatus, a liquid immersion exposure apparatus using the optical element, a liquid immersion exposure method using the liquid immersion exposure apparatus, and a method for producing a micro device using the liquid immersion exposure apparatus.

2. Related Background Art

A projection exposure apparatus that has been used conventionally in producing a semiconductor element and the like transfers the pattern image of a reticle, which serves as a mask, via a projection optical system in each shot region on a wafer (or a glass plate and the like) with a resist applied thereon to serve as a photosensitive substrate. A reduced projection exposure type of the exposure apparatus (stepper) using a step-and-repeat method has been conventionally used frequently as a projection exposure apparatus. A projection exposure apparatus using a step-and-scan method in which the reticle and the wafer are synchronously scanned for exposure has recently attracted attention.

The resolution of a projection optical system mounted in a projection exposure apparatus is increased as the wavelength of exposure light applied becomes shorter and as the numeric aperture (NA) in the projection optical system becomes larger. Hence, as an integrated circuit has achieved a finer scale, a wavelength of exposure light used in the projection exposure apparatus has become shorter and shorter every year. In addition, the NA in the projection optical system has been increasing as well. The main wavelength of exposure light at present is 248 nm of a KrF excimer laser. An ArF excimer laser with a shorter wavelength of 193 nm has also been put into practical use.

However, it is known that, as the NA is increasing as shown above, the depth of focus becomes smaller. Hence, a technology which allows achieving a high resolution while maintaining a large depth of focus has been studied. Hence, a liquid immersion method has been proposed in which a lithography process is performed with a higher resolution which is achieved by filling a gap between the bottom surface of the projection optical system and the surface of a substrate (wafer) with a liquid, such as water, and an organic solvent upon utilizing the fact that the wavelength of the exposure light in the liquid becomes 1/n-folds (n is the refraction index of the liquid, which is usually approximately between 1.2 and 1.6) of that in the air. For example, a liquid immersion exposure apparatus, which uses calcium fluoride (CaF₂) as an optical element on the bottom surface of the projection optical system, and pure water as the liquid, is disclosed in Japanese Unexamined Patent Application Publication No. 2004-207709. Also, in Japanese Unexamined Patent Application Publication No. 2005-202375, an optical element including a base material consisting of a fluoride crystal material, particularly calcium fluoride, and a protective layer system consisting of lanthanum fluoride (LaF₃) and the like mounted on the base material is disclosed as an optical element used in an exposure apparatus utilizing the liquid immersion method. However, further improvement in resolution is required.

### SUMMARY OF THE INVENTION

In order to achieve higher resolution, it has been discussed to change the liquid used to the one with a higher refraction index, as well as to change the base material of the optical element used in the liquid immersion method to the one with a higher refraction index. In an optical element using such a base material with a higher refraction index, a wider range of incidence angles than in the conventional optical element will be used according to the larger NA. However, no optical element using a base material with a high refraction index was found to exhibit excellent antireflective properties in a wide range of incidence angles.

The present invention was conducted in consideration of the above-mentioned conventional technical problems. The present invention is intended to provide an optical element which can exhibit excellent antireflective properties with an average reflectance of 2.0% or less to the light with a wavelength of 193 nm within an incidence angle range of 0 to 70° at the interface with a liquid while using a base material with a high refraction index and a liquid with a high refraction index. Provided also are a liquid immersion exposure apparatus using the optical element, a liquid immersion exposure method using the liquid immersion exposure apparatus, and a production method of micro devices utilizing the liquid immersion exposure apparatus.

The present inventors have devoted themselves to conduct intensive research in order to achieve objectives described above. As a result, they discovered that the objectives could be achieved by utilizing an optical element which includes predetermined antireflection films and a predetermined base material in a liquid immersion exposure apparatus in which the substrate is exposed by exposure light illuminated on the substrate via a liquid with a refraction index in a range between 1.60 and 1.66 to the light with a wavelength of 193 nm; thus, the present invention has been completed.

The optical element of the present invention is an optical element used such that at least one surface thereof is in contact with a liquid in a liquid immersion exposure apparatus in which a substrate is exposed by exposure light illuminated on the substrate via the liquid with a refraction index in a range between 1.60 and 1.66 to the light with a wavelength of 193 nm, comprising:

a base material with a refraction index in a range between 2.10 and 2.30 to the light with a wavelength of 193 nm; and

a first antireflection film formed on the contact surface between the base material and the liquid,

wherein the first antireflection film includes a first antireflection layer with a refraction index in a range between 1.80 and 2.02 to the light with a wavelength of 193 nm and an optical film thickness in a range between 0.25λ and 0.42λ to the wavelength λ of the exposure light,

a second antireflection layer with a refraction index in a range between 1.65 and 1.77 to the light with a wavelength of 193 nm and an optical film thickness in a range between 0.10λ and 0.45λ to the wavelength λ of the exposure light, and

the first antireflection layer and the second antireflection layer are sequentially laminated in an order from the base material side.

By using the optical element, it is possible to use a liquid with a high refraction index in combination with a base material with a high refraction index. Moreover, by using the optical element, it is possible to exhibit excellent antireflective properties with an average reflectance of 2.0% or less to the light with a wavelength of 193 nm in an incidence angle range between 0° and 70° at the interface with a liquid despite the use of a base material with a high refraction index.

In the optical element of the present invention, the optical film thicknesses of the first and second antireflection layers are preferably in a range between 0.30λ and 0.35λ and between 0.24λ and 0.375λ, respectively. Furthermore, in the optical element of the present invention, the physical film thicknesses of the first and second antireflection layers are preferably in a range between 31 nm and 37 nm and between 27 nm and 43 nm, respectively.

In a case where the thicknesses of the first and second antireflection layers are within the above-mentioned ranges, the optical element can exhibit excellent antireflective properties with an average reflectance of, for example, 1.0% or less to the light with a wavelength of 193 nm within an incidence angle range of 0° to 70° at the interface with the liquid.

Hence, an average reflectance of the optical element of the present invention is preferably 2.0% or less, more preferably 1.0% or less, to the light with a wavelength of 193 nm within an incidence angle range of 0° to 70° at the interface between the liquid and the first antireflection film.

In the optical element of the present invention, it is preferable that the first antireflection layer contain a metal oxide selected from the group consisting of aluminum oxide, gadolinium oxide, and scandium oxide.

By containing one of these metal oxides in the first antireflection layer, the refraction index of the first antireflection layer to the light with a wavelength of 193 nm is likely to be more efficiently brought to a range between 1.80 and 2.02, while a sufficient level of transparency is achieved.

In the optical element of the present invention, it is preferable that the second antireflection layer contain a metal fluoride selected from the group consisting of lanthanum fluoride, gadolinium fluoride, neodymium fluoride, hafnium fluoride, lutetium fluoride, yttrium fluoride, ytterbium fluoride, and dysprosium fluoride.

By containing one of these metal fluorides in the second antireflection layer, the refraction index of the second antireflection layer to the light with a wavelength of 193 nm is likely to be more efficiently brought to a range between 1.65 and 1.76, while a sufficient level of transparency is achieved.

Furthermore, in the optical element of the present invention, it is preferable that the base material contain a material for the base material selected from the group consisting of garnets and spinel ceramics.

By using such a material for the base material, it becomes possible to obtain a base material with a refraction index in a range between 2.10 and 2.30 to the light with a wavelength of 193 nm.

When the base material has a surface being in contact with gas in the optical element of the present invention, it is preferable that the second antireflection film be mounted on the surface of the base material being in contact with the gas. It is preferable that an average reflectance of the optical element additionally including the second antireflection film be 1.0% or less, more preferably 0.5%, to the light with a wavelength of 193 nm within an incidence angle range of 0° to 40° at the interface between the gas and the second antireflection film.

By providing the second antireflection film additionally, it becomes possible to sufficiently prevent the exposure light from being reflected at the interface between the gas and the second antireflection film.

The liquid immersion exposure apparatus of the present invention is a liquid immersion exposure apparatus illuminating exposure light on a substrate via an optical element and a liquid which fills the region between at least one of the optical element and a substrate, which and has a refraction index in a range between 1.60 and 1.66 to the light with a wavelength of 193 nm, wherein an optical element used such as to have contact with the liquid is the optical element of the present invention.

In the liquid immersion exposure apparatus, since the optical element of the present invention is used so as to have contact with the liquid, it is possible to sufficiently prevent exposure light from being reflected at the interface between the optical element and the liquid; thus, it becomes possible to perform lithography with a sufficiently high level of resolution.

The liquid immersion exposure method of the present invention includes a process of exposing a substrate by illuminating exposure light on the substrate via a liquid by using the liquid immersion exposure apparatus of the present invention.

The micro device production method of the present invention includes a process of exposing a substrate by illuminating exposure light on the substrate via a liquid by using the liquid immersion exposure apparatus of the present invention.

In the liquid immersion exposure method and the micro device production method of the present invention, since the liquid immersion exposure apparatus of the present invention is utilized, it is possible to perform sufficiently high quality lithography; thus, it is possible to efficiently and accurately produce devices which include more elaborate patterns.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of the projection exposure apparatus used in Embodiment 1.

FIG. 2 is a schematic cross-sectional view showing a construction of the optical element of Embodiment 1.

FIG. 3 is a schematic diagram showing the positional relationship among the top part of the optical element and the emission and inflow nozzles for the direction of X in the projection optical system described in FIG. 1.

FIG. 4 is a schematic diagram showing the positional relationship among the top part of the optical element and the emission and inflow nozzles for the direction of Y in the projection optical system described in FIG. 1.

FIG. 5 is an enlarged view of a main section showing the conditions of the supply of a liquid to the gap between the optical element and the wafer W and of the collection thereof in the projection optical system described in FIG. 1.

FIG. 6 is a schematic diagram of the projection exposure apparatus used in Embodiment 2.

FIG. 7 is a schematic diagram showing the positional relationship among the top part of the optical element and the emission and inflow nozzles for the direction of X in the projection optical system described in FIG. 6.

FIG. 8 is a schematic diagram showing the positional relationship among the top part of the optical element and the emission and inflow nozzles for the direction of Y in the projection optical system described in FIG. 6.

FIG. 9 is a schematic diagram of an exposure apparatus related to Embodiment 3.

FIG. 10 is a graph showing a relationship of the incidence angle of light with reflectances (Rs) and (Rp) of the optical element (with an optical film thickness of the second antireflection layer of 0.050λ), which was obtained in test examples 1 and 2, for polarizations s and p, respectively.

FIG. 11 is a graph showing a relationship of the incidence angle of light with reflectances (Rs) and (Rp) of the optical element (with an optical film thickness of the second antireflection layer of 0.10λ), which was obtained in test examples 3 and 4, for polarizations s and p, respectively.

FIG. 12 is a graph showing a relationship of the incidence angle of light with reflectances (Rs) and (Rp) of the optical element (with an optical film thickness of the second antireflection layer of 0.200λ), which was obtained in test examples 5 and 6, for polarizations s and p, respectively.

FIG. 13 is a graph showing a relationship of the incidence angle of light with reflectances (Rs) and (Rp) of the optical element (with an optical film thickness of the second antireflection layer of 0.300λ), which was obtained in test examples 7 and 8, for polarizations s and p, respectively.

FIG. 14 is a graph showing a relationship of the incidence angle of light with reflectances (Rs) and (Rp) of the optical element (with an optical film thickness of the second antireflection layer of 0.400λ), which was obtained in test examples 9 and 10, for polarizations s and p, respectively.

FIG. 15 is a graph showing a relationship of the incidence angle of light with reflectances (Rs) and (Rp) of the optical element (with an optical film thickness of the second antireflection layer of 0.500λ), which was obtained in test examples 11 and 12, for polarizations s and p, respectively.

FIG. 16 is a graph showing a relationship of the incidence angle of light with reflectances (Rs) and (Rp) of the optical element (with an optical film thickness of the first antireflection layer of 0.250λ), which was obtained in test examples 13 and 14, for polarizations s and p, respectively.

FIG. 17 is a graph showing a relationship of the incidence angle of light with reflectances (Rs) and (Rp) of the optical element (with an optical film thickness of the first antireflection layer of 0.300λ), which was obtained in test examples 15 and 16, for polarizations s and p, respectively.

FIG. 18 is a graph showing a relationship of the incidence angle of light with reflectances (Rs) and (Rp) of the optical element (with an optical film thickness of the first antireflection layer of 0.400λ), which was obtained in test examples 17 and 18, for polarizations s and p, respectively.

FIG. 19 is a graph showing the maximum and minimum values of the optical film thickness (nd) of the first antireflection layer with which it is possible to achieve an average reflectance of an optical element to the light with a wavelength of 193 nm of 2% or less and 1% or less, when the optical film thickness of the second antireflection layer is fixed.

FIG. 20 is a graph showing the maximum and minimum values of the optical film thickness (nd) of the second antireflection layer with which it is possible to achieve an average reflectance of an optical element to the light with a wavelength of 193 nm of 2% or less and 1% or less, when the optical film thickness of the first antireflection layer is fixed.

### DETAILED DESCRIPTION OF THE PREFERRED EMBODIMENTS

The present invention will be described in detail according to the preferred embodiments in the following section.

The present invention relates to an optical element used in a liquid immersion exposure apparatus using a liquid immersion method which is used to transfer a certain pattern on a photosensitive substrate in a lithographic process for producing micro devices, such as semiconductor elements, an image pickup devices (CCD and the like), liquid crystal display devices, and thin film magnetic heads, a liquid immersion exposure apparatus using the optical element, a liquid immersion exposure method using the liquid immersion exposure apparatus, and a production method of micro devices utilizing the liquid immersion exposure apparatus.

Firstly, the optical element of the present invention will be described. The optical element of the present invention is an optical element used such that at least one surface thereof is in contact with a liquid in a liquid immersion exposure apparatus in which a substrate is exposed by exposure light illuminated on the substrate via the liquid with a refraction index in a range between 1.60 and 1.66 to the light with a wavelength of 193 nm, comprising:

a base material with a refraction index in a range between 2.10 and 2.30 to the light with a wavelength of 193 nm; and

a first antireflection film formed on the contact surface between the base material and the liquid,

wherein the first antireflection film includes a first antireflection layer with a refraction index in a range between 1.80 and 2.02 to the light with a wavelength of 193 nm and an optical film thickness in a range between 0.25λ and 0.42λ to the wavelength λ of the exposure light,

a second antireflection layer with a refraction index in a range between 1.65 and 1.77 to the light with a wavelength of 193 nm and an optical film thickness in a range between 0.10λ and 0.45λ to the wavelength λ of the exposure light, and

the first antireflection layer and the second antireflection layer are sequentially laminated in an order from the base material side.

By using the optical element, it is possible to exhibit excellent antireflective properties with an average reflectance of 2.0% or less to the light with a wavelength of 193 nm in an incidence angle range of 0° to 70° at the interface with a liquid; thus, it becomes possible to perform lithography with a sufficiently high level of resolution.

The optical element is to be used such that at least one surface thereof is in contact with a liquid in a liquid immersion exposure apparatus in which a substrate is exposed by exposure light illuminated on the substrate via the liquid with a refraction index in a range between 1.60 and 1.66 to the light with a wavelength of 193 nm. Although there is no particular limitation in the selection of a liquid used as above in combination with the optical element as long as the liquid has a refraction index in a range between 1.60 and 1.66 to the light with a wavelength of 193 nm, it is preferable that the refraction index be in a range between 1.63 and 1.65. If a refraction index of a liquid is less than 1.60, it is difficult to obtain a sufficient NA due to the low refraction index of the liquid.

One example of such liquids is decalin (C₁₀H₁₈).

The optical element includes the base material with a refraction index in a range between 2.10 and 2.30 to the light with a wavelength of 193 nm, and the first antireflection film formed on the contact surface between the base material and a liquid.

There is no particular limitation in the selection of a base material used as above as long as it has a refraction index in a range between 2.10 and 2.30 to the light with a wavelength of 193 nm. If the refraction index of the base material used as above is less than 2.10, it is difficult to obtain enough NA due to the low refraction index of the base material. On the other hand, if the refraction index of the base material used exceeds above 2.30, the difference in a refraction index between the substrate and the liquid becomes large due to the excessively high refraction index of the base material; thus, it becomes impossible to exhibit excellent antireflective properties even if the first antireflection film is formed on the base material.

Based on its refraction index at a wavelength of 193 nm and the possibility of achieving a sufficient level of permeability in a practical application at a wavelength used, it is preferable to select a material for the base material selected from the group consisting of garnets (lutetium aluminum garnet [LuAG], germanate and the like) and spinel ceramics (Mg₂Al₂O₄ and the like), and, it is more preferable to select any one of those containing LuAG or Mg₂Al₂O₄. Any methods available in the public domain can be used accordingly for production of the base material.

The first antireflection film is formed by sequentially laminating (i) the first antireflection layer with a refraction index (n) in a range between 1.80 and 2.02 to the light with a wavelength of 193 nm and an optical film thickness (nd) in a range between 0.25λ and 0.42λ to the wavelength λ of the exposure light and (ii) the second antireflection layer with a refraction index (n) in a range between 1.65 and 1.77 to the light with a wavelength of 193 nm and an optical film thickness (nd) in a range between 0.10λ and 0.45λ to the wavelength λ of the exposure light in the order from the substrate side.

By setting the refraction index and optical film thickness of the first and second antireflection layers in the ranges described in the (i) and (ii) above, respectively, it becomes possible to achieve an average reflectance of an optical element of 2% or less to the light with a wavelength of 193 nm within an incidence angle range of 0° to 70° at the interface between an optical element using a base material with a refraction index in a range between 2.10 and 2.30 and a liquid with a refraction index in a range between 1.60 and 1.66; thus, it becomes possible to provide an optical element with antireflective properties sufficient for practical use.

As such a first antireflection layer, it is preferable to use a first antireflection layer containing a metal oxide selected from the group consisting of aluminum oxide, gadolinium oxide, and scandium oxide. By using such metal oxides to form the first antireflection layer, it becomes possible to efficiently achieve a refraction index between 1.80 and 2.02 of the first antireflection layer to the light with a wavelength of 193 nm while a sufficient level of transparency is maintained.

In the optical element of the present invention, it is preferable to use the second antireflection layer containing a metal fluoride selected from the group consisting of lanthanum fluoride, gadolinium fluoride, neodymium fluoride, hafnium fluoride, lutetium fluoride, yttrium fluoride, ytterbium fluoride, and dysprosium fluoride. By using such metal fluorides to form the second antireflection layer, it becomes possible to efficiently achieve a refraction index between 1.65 and 1.77 of the second antireflection layer to the light with a wavelength of 193 nm.

There is no particular limitation in the selection of a method to form the first and second antireflection layers, and any methods available in the public domain, such as vacuum deposition method, an ion beam assist deposition method, a gas cluster ion beam assist deposition method, an ion plating method, an ion beam spattering method, a magnetron spattering method, a bias spattering method, ECR (Electron Cyclotron Resonance) spattering method, a high frequency (RF) spattering method, a heat CVD (Chemical Vapor Deposition) method, a plasma CVD method, and a light CVD method, can be used accordingly. There is no particular limitation in the selection of a method to control the refraction indexes of the first and second antireflection layers, and any methods available in the public domain can be used accordingly. For example, a method, in which production conditions, such as composition of the materials used to form the first and second reflection layers, level of vacuum, level of power supplied, temperature of a base material, are controlled accordingly, may be used.

In the optical element of the present invention, it is preferable that the optical film thickness (nd) of the first antireflection layer be in a range between 0.30λ and 0.35λ, and the optical film thickness (nd) of the second antireflection layer is in a range between 0.24λ and 0.375λ. Furthermore, in the optical element of the present invention, it is preferable that the physical film thickness (d) of the first antireflection layer be in a range between 31 nm and 37 nm, and the physical film thickness (d) of the second antireflection layer is in a range between 27 nm and 43 nm. By using the first and second antireflection layers with the optical film thickness (nd) and physical film thickness (d) in the above-mentioned ranges, it becomes possible to exhibit excellent antireflective properties with an average reflectance of 1.0% or less to the light with a wavelength of 193 nm within a range of an incidence angle between 0° and 70° at the interface between the liquid and the first antireflection film; thus, it becomes possible to perform lithography with higher resolution.

Furthermore, in the optical element of the present invention, when the optical film thickness of the second antireflection layer is in a range between 0.1 and 0.3λ, it is preferable that the optical film thicknesses of the first antireflection layer and the second antireflection layer do not satisfy the relationship expressed in the following mathematical formula 1.

Y<−0.53x+0.41 (Mathematical formula 1)

### [In the formula, Y represents an optical film thickness of the first antireflection layer, and X represents an optical film thickness of the second antireflection layer.]

### In a case where the optical film thickness of the second antireflection layer in a range between 0.1λ and 0.3λ, if the relationship expressed in the formula 1 is satisfied, an average reflectance tends to exceed 2.0%.

As the optical element of the present invention, it is preferable that an average reflectance be 2.0% (more preferably 1.0%) or less to the light with a wavelength of 193 nm within an incidence angle range of 0° to 70° at the interface between the liquid and the first antireflection film. By using the optical element with such an average reflectance, it tends to become possible to perform lithography with higher resolution. A term “average reflectance” used herein indicates an average value (Ra) of a reflectance (Rs) for polarization s and a reflectance (Rp) for polarization p, and is calculated by using the mathematical formula 2 below.

Ra=(Rs+Rp)/2 (Mathematical Formula 2)

One of the methods for measuring the reflectances Rs and Rp is to measure a reflectance (Rs) for polarization s and a reflectance (Rp) for polarization p individually using U4100 spectrophotometer manufactured by Hitachi High-Technologies Corporation.

Furthermore, in the optical element of the present invention, it is preferable that the optical element of the present invention additionally include a second antireflection film on the surface where the base material has contact with the gas, when the base material has a surface being in contact with the gas. By forming such a second antireflection film on the surface being in contact with gas, it becomes possible to reduce an average reflectance of the optical element at the interface between the optical element and the gas; thus, it is likely to be possible to efficiently prevent loss of light volume.

As the second antireflection film, it is preferable to use a second antireflection film which can achieve an average reflectance of 1.0% or less (more preferably 0.5%) to the light with a wavelength of 193 nm within an incidence angle range of 0° to 40° at the interface between gas and the second antireflection film. By including the second antireflection film with such an average reflectance, it is likely to become possible to efficiently prevent loss of light volume; thus, it becomes possible to perform lithography with higher resolution. There is no particular limitation in the structure of a second antireflection film, and the film may consist of a single layer or multiple layers.

There is no particular limitation in the selection of a material to form the above-mentioned second antireflection film. Any materials available in the public domain, which can achieve an average reflectance of 1.0% or less to the light with a wavelength of 193 nm within an incidence angle range of 0° to 40° at the interface between the gas and the second antireflection film, can be used accordingly. Such materials include aluminum oxide, magnesium fluoride, aluminum fluoride, cryolite, lanthanum fluoride, gadolinium fluoride, neodymium fluoride, hafnium fluoride, lutetium fluoride, yttrium fluoride, ytterbium fluoride, dysprosium fluoride, and the like.

There is no particular limitation in the selection of a method to form the above-mentioned second antireflection film. The following methods available in the public domain may be used accordingly: a vacuum deposition method, an ion beam assist deposition method, a gas cluster ion beam assist deposition method, an ion plating method, an ion beam spattering method, a magnetron spattering method, a bias spattering method, an ECR (Electron Cyclotron Resonance) spattering method, a high frequency (RF) spattering method, a heat CVD (Chemical Vapor Deposition) method, a plasma CVD method, and a light CVD method. There is no particular limitation in the selection of a method to control a refraction index of the second antireflection film, and any methods available in the public domain can be used accordingly. For example, a method in which production conditions, such as composition of the materials used to form the second reflection layers, level of vacuum, level of power supplied, temperature of a base material, are controlled accordingly, may be used.

In the optical element of the present invention, a liquid repellent film may additionally be formed in a partial area of the surface of the optical element (preferably a part not being in contact with a liquid) as necessary. For example, by forming a liquid repellent film in a partial region where no exposure light penetrates, while liquid-permeability of a part of the surface of the optical element being in contact with liquid, which is a partial region necessary to project exposure light, is maintained, it becomes possible to attach the liquid more closely to the surface of the partial region necessary for projecting exposure light; thus, it becomes more likely to be able to perform lithography with higher resolution.

There is no particular limitation in the selection of a material to form the above-mentioned liquid-repellent film. Any liquid-repellent materials available in the public domain can be used accordingly, as the material for the liquid-repellent film. Such materials include fluorine-based resin materials, such as polyethylene tetrafluoride, acryl-based resin materials, and silicon-based resin materials. Furthermore, there is no particular limitation in the selection of a method to form the liquid-repellent films, and any methods available in the public domain, such as those in which the above-mentioned liquid-repellent materials are applied on an optical element, and a thin film consisting of the above-mentioned liquid-repellent materials is attached to an optical element, can be used accordingly.

In the optical element of the present invention, a light shielding film may be formed as necessary in a partial region where no exposure light penetrates. There is no particular limitation in the selection of a material for light shielding film. Any materials available in the public domain can be used accordingly to form such light shielding films, such as metals including gold (Au), platinum (Pt), silver (Ag), nickel (Ni), tantalum (Ta), tungsten (W), palladium (Pd), molybdenum (Mo), titan (Ti) and chromium (Cr); and metal oxides including zirconium dioxide (ZrO₂), hafnium dioxide (HfO₂), titanium dioxide (TiO₂), tantalum pentoxide (Ta₂O₅), silicon oxide (SiO) and chromium oxide (Cr₂O₃). Furthermore, there is no particular limitation in the selection of a production method of the light-shielding film, and any methods available in the public domain can be used accordingly.

Furthermore, in the optical element of the present invention, a metallic dissolution preventing film (that also serves as a film to strengthen adherence) may be formed as necessary in a region where no exposure light penetrates. There is no particular limitation in the selection of metallic dissolution preventing films, and any films which consist of at least one of the following metals can be used: tantalum (Ta), gold (Au), platinum (Pt) silver (Ag), nickel (Ni), tungsten (W), palladium (Pd), molybdenum (Mo), titan (Ti), and chromium (Cr).

In the optical element of the present invention, in a case where a metallic dissolution preventing film (that also serves as a film to strengthen adherence) is formed in a partial region where no exposure light penetrates, a protective films for the metallic dissolution preventing film (dissolution-preventing-film-protective film) may additionally be formed as necessary in order to protect the metallic dissolution preventing film. Such protective films for the metallic dissolution preventing film may include films which consist of at least one of silicon dioxide (SiO₂), yttrium oxide. (Y₂O₃), neodymium fluoride (NdF₃), chromium oxide (Cr₂O₃), tantalum pentoxide (Ta₂O₅), niobium pentoxide (Nb₂O₅), titanium dioxide (TiO₂), zirconium dioxide (ZrO₂), hafnium dioxide (HfO₂), and lanthanum oxide (La₂O₃). As described above, there is no particular limitation in the selection of materials for the protective film for the metallic dissolution preventing film. The most suitable material can be selected according to some parameters, such as a base material of the optical element, the environment in which the optical element is mounted, the type of a liquid which is filled between the surface of the substrate and the projection optical system, to form a protective film for a metallic dissolution preventing film (a dissolution-preventing-film-protective film).

The preferred embodiment of the optical element of the present invention has been described above. In the following section, the preferred embodiment for the liquid immersion exposure apparatus of the present invention which includes the optical element of the present invention, and the liquid immersion exposure method of the present invention using the liquid immersion exposure apparatus will be described by referring to figures. In the following descriptions and figures, the same or corresponding elements are assigned with the same symbols, and duplicate descriptions will be omitted.

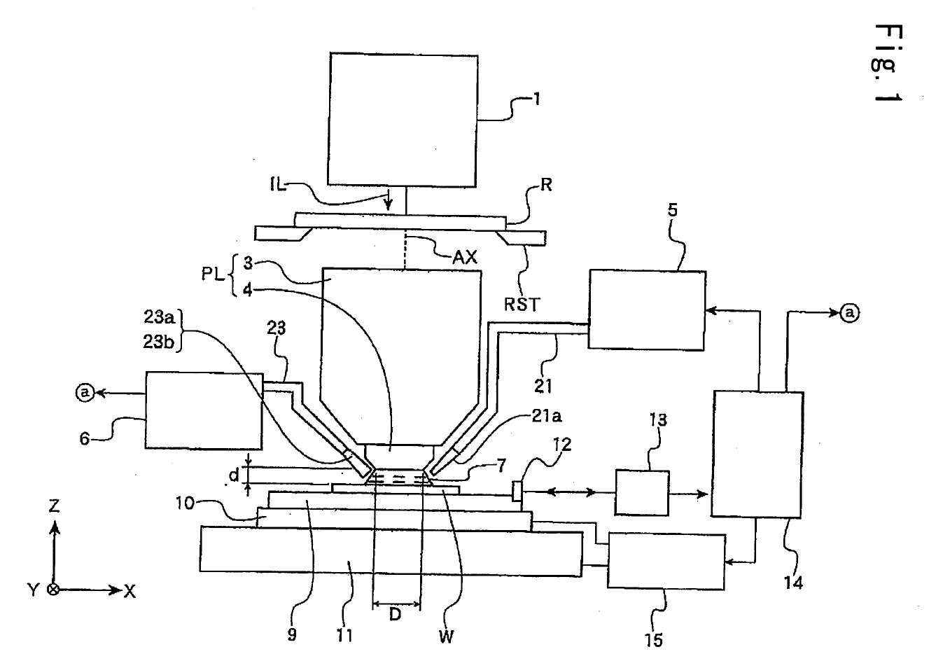

FIG. 1 shows a schematic construction of the liquid immersion exposure apparatus related to Embodiment 1 using a step-and-repeat method. In the following description, the XYZ rectangular coordinate system shown in FIG. 1 is set to describe the positional relationship among individual parts while referring to this XYZ rectangular coordinate system. In this XYZ rectangular coordinate system, X and Y axes are set to locate parallel to a substrate (wafer) W, and Z axis is set to locate orthogonally to the wafer W. The XYZ coordinate system described in the figure includes the XY plane parallel to the horizontal plane, and the Z axis running along the vertical direction in the real world.

The liquid immersion exposure apparatus related to Embodiment 1 includes an ArF excimer laser light source as an exposure light source, and an illumination optical system 1 consisting of an optical integrator (homogenizer), a field stop, a condenser lens, and the like, as shown in FIG. 1.

In such a liquid immersion exposure apparatus, first, an exposure light (exposure beam) IL consisting of ultraviolet pulse light with a wavelength of 193 nm which is emitted from a light source passes through an illumination optical system 1 and illuminates a pattern mounted on a reticle (mask) R. Then, the light, which has passed through the reticle R, performs reduced projection exposure at a predetermined projection magnification β (for example, β is ¼ or ⅕, and so on) on the exposure region on the wafer W, on which a photoresist is applied, via a two-sided (or one-sided on the wafer W side) telecentric projection optical system PL. In such a manner, it is possible to expose the wafer W to a certain pattern using the liquid immersion exposure apparatus shown in FIG. 1.

There is no particular limitation in the selection of exposure light IL. According to a purpose, in addition to an ArF excimer laser light (193 nm), a KrF excimer laser light (wavelength 248 nm), a F₂ laser light (wavelength 157 nm), or an i-ray of a mercury light (wavelength 365 nm) may be used, as the exposure light IL.

The reticle R is held on a reticle stage RST. The reticle stage RST includes a mechanism which causes micromotion of the reticle R in the X, Y, and rotational directions. The positions of the reticle stage RST in the X, Y, and rotational directions are measured in real time, and controlled, by using a reticle laser interferometer (not shown in the figure).

Furthermore, the wafer W is fixed on a Z stage 9 by a wafer holder (not shown in the figure). The Z stage 9 is fixed on the XY stage 10, which moves along the XY plane substantially parallel to the image plane of the projection optical system PL, and controls a focus position (a position in the direction of Z) and an inclined angle of the wafer W. The positions of the Z stage 9 in the X, Y, and rotational directions are measured in real time and controlled by a wafer laser interferometer 13 using a moving mirror 12 on the Z stage 9. An XY stage 10, which is disposed on a base 11, controls the X, Y, and rotational directions of the wafer W.

The main control system 14 mounted in the liquid immersion exposure apparatus adjusts the positions of the reticle R in the X, Y, and rotational directions based on the measurement values obtained by the reticle laser interferometer. In other words, the main control system 14 adjusts the position of the reticle R by transmitting control signals to the system mounted in the reticle stage RST to cause micromotion of the reticle stage RST.

The main control system 14 adjusts the focus position (position in the direction of Z) of the wafer W and inclined angle thereof in order to coordinate the surface on the wafer W to the image plane of the projection optical system PL by using an auto focus method and auto leveling method. In other words, the main control system 14 adjusts the focus position of the wafer W and inclined angle thereof by transmitting control signals to the wafer stage drive system 15 to drive the Z stage 9 by the wafer stage drive system 15. Furthermore, the main control system 14 adjusts the positions of the wafer W in the X, Y, and rotational directions based on the measurement values obtained by the wafer laser interferometer 13. In other words, the main control system 14 adjusts the position of the wafer W in the X, Y, and rotational directions by transmitting control signals to the wafer stage drive system 15 to drive the XY stage 10 by the wafer stage drive system 15.

Upon exposure, the main control system 14 stepwisely moves each shot area on the wafer W to an exposure position sequentially by driving the XY stage 10 with the wafer stage drive system 15 by transmitting control signals to the wafer stage drive system 15. In other words, an operation in which the wafer W is exposed to a pattern image of the reticle R is repeated by using a step-and-repeat method.

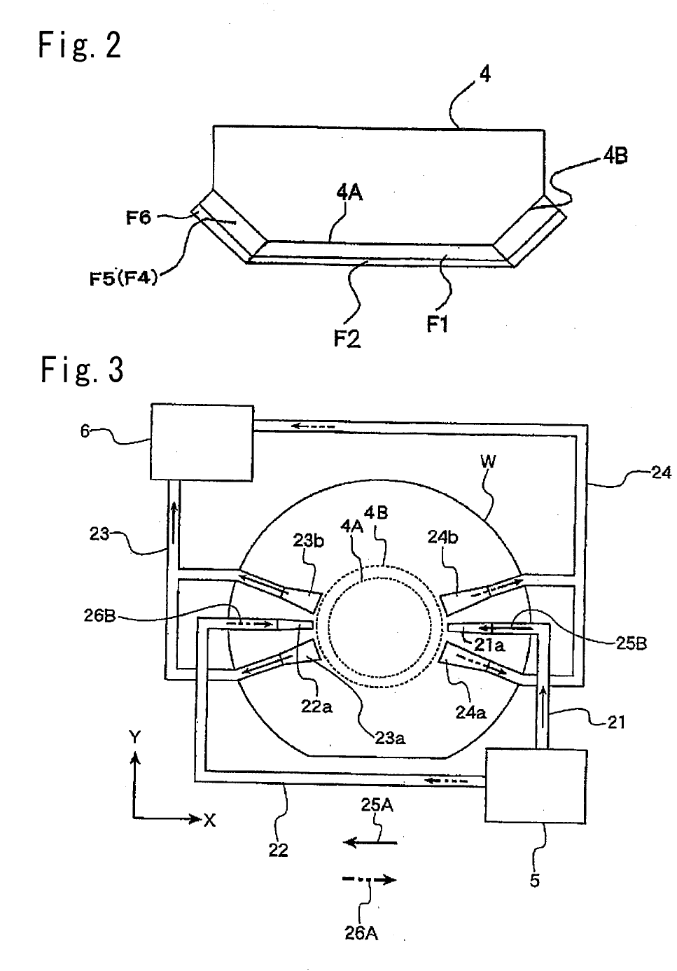

In a liquid immersion type of a liquid immersion exposure apparatus utilizing the liquid immersion method, a predetermined liquid 7 is filled in a gap between the surface of the wafer W and the optical element 4 on the wafer W side of the projection optical system PL, at least while a pattern image of the reticle R is being transferred on the wafer W. A projection optical system PL has a mirror cylinder 3 which stores several optical elements which constitute the projection optical system PL. In the projection optical system PL, the optical element 4 locating most closely to the wafer W side is formed by the optical element of the present invention, and it is constructed that only the surface of the optical element 4 (a top part 4A on the wafer W side and a tapered section 4B (refer to FIG. 2)) is in contact with a liquid 7. This construction prevents the mirror cylinder 3 made of metal from being eroded

Here, the base material of the optical element 4 (a preferred embodiment of the optical element of the present invention) shown in FIG. 2 is LuAG, and the crystal orientation of the film formation surface is (100) plane. The above-mentioned first antireflection film is formed at the top part 4A on the wafer W side of the base material, which is a partial region where exposure light penetrates. Such an antireflection film includes Al₂O₃ (the first antireflection layer) F1 and LaF₃ (the second antireflection layer) F2.

In the present embodiment, a tantalum (Ta) film F5 (F4) is formed as a metallic dissolution preventing film (that also serves as a film to strengthen adherence) by a spattering method on the tapered surface 4B of the optical element 4, which is a partial region where no exposure light penetrates. On the surface of the metallic dissolution preventing film (dissolution preventing film) F5, a silicon dioxide (SiO₂) film F6 is formed as a protective film for the metallic dissolution preventing film (dissolution-preventing-film-protecting film) by a wet film formation method for protection of the metallic dissolution preventing film. The solubility of the metallic dissolution preventing film (dissolution preventing film) F5 which is formed on the tapered surface 4B of the optical element 4 to pure water is 2 ppt or less, and the packing density is 95% or above.

Decalin (C₁₀H₁₈) with a refraction index of 1.64 to the light with a wavelength of 193 nm is used as a liquid 7. The optical element 4 exhibits an average reflectance of 2% or less within an incidence angle range of 0° to 70° of exposure light (the present embodiment: 193 nm) at the interface between the first antireflection film formed at the top part 4A of the optical element 4 and the liquid 7.

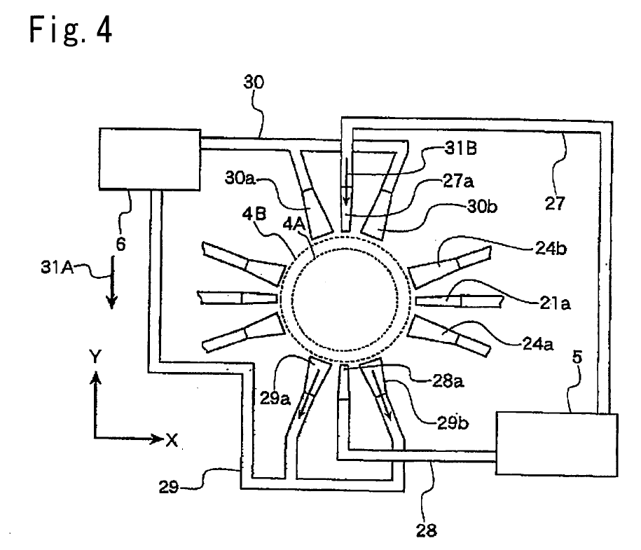

FIG. 3 shows the positional relationship among the top part 4A and the tapered surface 4B on the wafer W side of the optical element 4 of the projection optical system PL, the wafer W, and two pairs of an emission and inflow nozzles which sandwich the top part 4A and tapered surface 4B on the wafer W side in the direction of X. FIG. 4 shows the positional relationship among the top part 4A and tapered surface 4B on the wafer W side of the optical element 4 of the projection optical system PL, and two pairs of an emission nozzle and inflow nozzle which sandwich the top part 4A and tapered surface 4B on the wafer W side in the direction of Y. The liquid immersion exposure apparatus related to the present embodiment includes a liquid supply equipment 5 which controls the supply of the liquid 7, and a liquid collection equipment 6 which controls the emission of the liquid 7.

The liquid supply equipment 5 includes a tank for the liquid 7 (not shown in the figure), a pressure pump (not shown in the figure), and a temperature control system (not shown in the figure). As shown in FIG. 3, the liquid supply equipment 5 is connected to the emission nozzle 21a with a thin top part section in the direction of +X of the top part 4A and the tapered surface 4B on the wafer W side and the emission nozzle 22a with a thin top part section in the direction of −X of the top part 4A and the tapered surface 4B on the wafer W side via supply pipes 21 and 22, respectively. As shown in FIG. 4, the liquid supply equipment 5 is connected to the emission nozzle 27a with a thin top part section in the direction of +Y of the top part 4A and the tapered surface 4B on the wafer W side and the emission nozzle 28a with a thin top part section in the direction of −Y of the top part 4A and the tapered surface 4B on the wafer W side via supply pipes 27 and 28, respectively. The liquid supply equipment 5 controls the temperature of the liquid 7 with the temperature control equipment, and supplies the temperature-controlled liquid 7 on the wafer W via at least one of the supply pipes 21, 22, 27, and 28 from at least one of the emission nozzles 21a, 22a, 27a, and 28a. The temperature of the liquid 7 is set by the temperature control system, for example, at the approximately same temperature as that in a chamber in which the liquid immersion exposure apparatus related to the present embodiment is accommodated.

The liquid collection equipment 6 includes a tank for the liquid 7 (not shown in the figure), a suction pump (not shown in the figure), and the like. As shown in FIG. 3, the liquid collection equipment 6 is connected to the inflow nozzles 23a and 23b with a wide top part in the direction of −X of the tapered surface 4B and the inflow nozzles 24a and 24b with a wide top part in the direction of +X of the tapered surface 4B via collection pipes 23 and 24, respectively. The inflow nozzles 23a, 23b, 24a, and 24b are disposed spreading like a fan against the line parallel to the X axis running through the center of the top part 4A on the wafer W side. As shown in FIG. 4, the liquid collection equipment 6 is connected to the inflow nozzles 29a and 29b with a wide top part in the direction of −Y of the tapered surface 4B and the inflow nozzles 30a and 30b with a wide top part in the direction of +Y of the tapered surface 4B via collection pipes 29 and 30, respectively. The inflow nozzles 29a, 29b, 30a, and 30b are disposed spreading like a fan against the line parallel to the Y axis running through the center of the top part 4A on the wafer W side.

The liquid collection equipment 6 collects the liquid 7 from on the wafer W via at least one of the collection pipes 23, 24, 29, and 30 via at least one of the inflow nozzle pairs 23a and 23b, 24a and 24b, 29a and 29b, and 30a and 30b.

A method for supplying and collecting the liquid 7 is described. In FIG. 3, the liquid supply equipment 5 supplies the liquid 7 to the gap among the top part 4A and tapered surface 4B on the wafer W side of the optical element 4 and the wafer W via the supply pipe 21 and the emission nozzle 21a when the wafer W is stepwisely moved in the direction (−X direction) indicated by a solid arrow 25A. The liquid collection equipment 6 collects the liquid 7 from the top of the wafer W, which was supplied by the liquid supply equipment 5 to the gap among the top part 4A and tapered surface 4B on the wafer W side and the wafer W, via the collection pipe 23 and the inflow nozzles 23a and 23b. In this case, the liquid 7 flows in the direction indicated by an arrow 25B (−X direction) on the wafer W; thus, the gap between the wafer W and the optical element 4 is stably filled with the liquid 7.

On the other hand, in FIG. 3, the liquid supply equipment 5 supplies the liquid 7 to the gap between the top part 4A and tapered surface 4B on the wafer W side of the optical element 4 and the wafer W via the supply pipe 22 and the emission nozzle 22a when the wafer W is stepwisely moved in the direction (+X direction) indicated by an chain-dashed arrow 26A. The liquid collection equipment 6 collects the liquid 7, which was supplied by the liquid supply equipment 5 to the gap among the top part 4A and tapered surface 4B on the wafer W side and the wafer W, via the collection pipe 24 and the inflow nozzles 24a and 24b. In this case, the liquid 7 flows on the wafer W in the direction indicated by an arrow 26B (+X direction); thus, the gap between the wafer W and the optical element 4 is stably filled with the liquid 7.

When the wafer W is stepwisely moved in the direction of Y, the liquid 7 is supplied or collected from the Y direction. In other words, in FIG. 4, the liquid supply equipment 5 supplies the liquid 7 via the supply pipe 27 and emission nozzle 27a when the wafer W is stepwisely moved in the direction indicated by an solid arrow 31A (−Y direction). The liquid collection equipment 6 collects the liquid 7, which was supplied by the liquid supply equipment 5 to the gap among the top part 4A and tapered surface 4B on the wafer W side and the wafer W, via the collection pipe 29 and the inflow nozzles 29a and 29b. In this case, the liquid 7 flows on the exposure region in the direction indicated by an arrow 31B (−Y direction); thus, the gap between the wafer W and the optical element 4 is stably filled with the liquid 7.

When the wafer W is stepwisely moved in the direction of Y, the liquid supply equipment 5 supplies the liquid 7 via the supply pipe 28 and emission nozzle 28a. The liquid collection equipment 6 collects the liquid 7, which was supplied by the liquid supply equipment 5 to the gap between the top part 4A on the wafer W side and the wafer W, via the collection pipe 30 and the inflow nozzles 30a and 30b. In this case, the liquid 7 flows on the exposure region in the direction of +Y; thus, the gap between the wafer W and the optical element 4 is stably filled with the liquid 7.

In addition to the nozzles for supplying and collecting the liquid 7 from the direction of X or direction of Y, nozzles for supplying and collecting the liquid 7 from, for example, a sideways direction may be mounted.

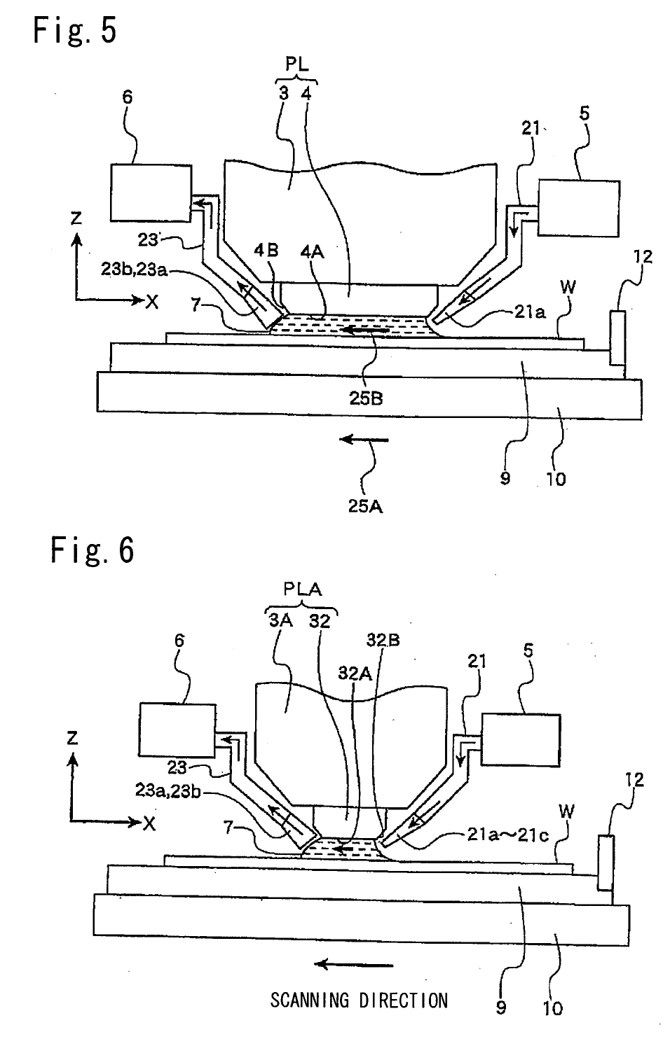

A method for controlling the amounts of the liquid 7 supplied and collected will then be described. FIG. 4 shows the status in which the liquid 7 is supplied to the gap between the optical element 4 constructing the projection optical system PL and the wafer W, and collected. FIG. 5 is an enlarged view of the main region, which shows the status in which a liquid is supplied to the gap between the optical element in the projection optical system shown in FIG. 1 and the wafer W and collected. As shown in FIGS. 4 and 5, in a case where the wafer W is moved in the direction indicated by an arrow 25A (−X direction), the liquid 7 which was supplied via the nozzle 21a flows in the direction indicated by an arrow 25B (−X direction), and is collected via the inflow nozzles 23a and 23b. Even while the wafer W is moved, the supplied amount Vi (m³/s) and collected amount Vo (m³/s) of the liquid 7 are made to be equal in order to keep a constant amount of the liquid 7, which is filled in the gap between the optical element 4 and the wafer W. The supplied amount Vi and collected amount Vo of the liquid 7 are adjusted based on the migration speed v of the XY stage 10 (wafer W). Hence, the supplied amount Vi and collected amount Vo of the liquid 7 are calculated based on a mathematical formula 3.

Vi=Vo=D·v·d (Mathematical Formula 3)

where D is the diameter (m) of the top part 4A of the optical element 4 as shown in FIG. 1, v is the migration speed of the XY stage 10 (m/s), and d is the working distance (m) of the projection optical system PL. The speed v at which the XY stage 10 is stepwisely moved is set by the main control system 14. D and d are previously input. Hence, by calculating and controlling the supplied amount Vi and collected amount Vo of the liquid 7 based on the Formula 2, the gap between the optical element 4 and the wafer 4 is always filled with the liquid 7.

The working distance d of the projection optical system PL is preferably as small as possible in order to hold the liquid 7 stably in the gap between the optical element 4 and the wafer W. For example, the working distance d of the projection optical system PL is set to be approximately 2 mm.

According to such liquid immersion exposure apparatus related to the first embodiment (Embodiment 1) reflection of exposure light is sufficiently prevented at the interface between a liquid and the first antireflection film because the above-mentioned first antireflection film is formed on the surface of the optical element being in contact with a liquid. As a result, undesirable events, such as reduction in the volume of light, and occurrence of flare and ghost, are sufficiently prevented; thus, it becomes possible to perform lithography with higher resolution.

According to the liquid immersion exposure apparatus related to the first embodiment, it is possible to make a metallic dissolution preventing film adhere closely to the optical element 4, since the metallic dissolution preventing film which also serves as a film to strengthen adherence has been formed on the tapered surface 4B of the optical element 4 on the wafer W side of the projection optical system PL. Since a silicon dioxide film (SiO₂) has also been formed on the surface of the metallic dissolution preventing film, it is possible to protect the metallic dissolution preventing film by preventing any damage on the film which is soft and has a low abrasion resistance. Hence, it is possible to maintain the optical properties of the projection optical system PL by preventing the liquid 7 filled in the gap between the surface of the wafer W and the projection optical system PL from penetrating into and degrading the optical element 4.

Since the metallic dissolution preventing film is formed on the tapered surface 4B of the optical element 4, which is a region where no exposure light IL penetrates, it is possible to continue exposure under the optimum condition without blocking the exposure light IL with the metallic dissolution preventing film formed on the surface of the optical element 4.

The refraction index n of the liquid 7 (decalin) to light with a wavelength of 193 nm is approximately 1.64. Since the wavelength of ArF excimer laser light with a wavelength of 193 nm is shortened to be 1/n of the original on the wafer W, that is 118 nm, it becomes possible to obtain a sufficiently high level of resolution. Furthermore, since a depth of focus is expanded by approximately n times compared to in the air, which is 1.64 times, it becomes possible to increase the NA of the projection optical system PL, if it is only required to acquire the equivalent level of depth of focus to that in the air. This also contributes to the improvement in resolution.

According to the liquid immersion exposure apparatus related to Embodiment 1, the gap between the wafer and the optical element can be continuously and stably filled with a liquid even when the wafer moves in the directions of +X, −X, +Y, or −Y, since two pairs of the emission nozzles and inflow nozzles, which are disposed inverted with respect to each other in the directions of X and Y, are installed.

Since a liquid flows on the wafer, when foreign matters attached on the wafer, the foreign matters can be flushed off with the liquid. Furthermore, since the temperature of the liquid is controlled to a predetermined temperature with the liquid supply equipment, the temperature of the surface of the wafer can be kept constant; thus, it is possible to prevent loss of precision in superposition due to thermal expansion of the wafer caused during exposure. Hence, even in a case where there is a time lag between alignment and exposure, like alignment by EGA (Enhanced Global Alignment) method, loss of precision in superposition due to thermal expansion of the wafer can be prevented.

According to such liquid immersion exposure apparatus related to the first embodiment, since the liquid flows in the same direction as that of the wafer is moved, a liquid which has caught foreign matters and absorbed heat can be collected by the liquid collection equipment without leaving the liquid to stay on the exposure region immediately beneath the surface of the optical element.

Embodiment 1 has been described above. The use of the liquid immersion exposure apparatus of the present invention is not limited to the above-mentioned embodiment. For example, the liquid immersion exposure apparatus related to the first embodiment uses an optical element, in which the first antireflection film consisting of an Al₂O₃ layer (the first antireflection layer) and LaF₃ layer (the second antireflection layer) are formed on the surface of LuAG (the base material) being in contact with a liquid. However, there is no particular limitation in the selection of an optical element as long as the optical element of the present invention is used. For such an optical element, the above-mentioned second antireflection film may be additionally formed on a surface of the optical element being in contact with gas.

In the above-mentioned embodiment, decalin (C₁₀H₁₈) is used as the liquid 7. As the liquid, any one of liquids equivalent to those described above in the optical elements of the present invention can be used accordingly.

In the liquid immersion exposure apparatus related to the first embodiment, a protective film for a metallic dissolution preventing film is formed by a wet-type film formation method. For formation of the film, any one of dry-type film formation methods, such as a spattering method, may be used.

In the tapered surface of the optical element related to the first embodiment, a metallic dissolution preventing film (that also serves as a film to strengthen adherence) and a protective film for the metallic dissolution preventing film are formed. However, only a metallic dissolution preventing film (dissolution preventing film) may be formed. Alternatively, a film which strengthens adherence and metallic dissolution preventing film may be formed separately. A film which strengthens adherence and a metallic dissolution preventing film may be formed, or a film which strengthens adherence, a metallic dissolution preventing film, and a protective film for the metallic dissolution preventing film may be formed.

In the above-mentioned embodiment, the gap between the surface of the wafer and the surface of the optical element on the wafer side of the projection optical system is filled with a liquid. A part of the gap between the surface of a wafer and the surface of the optical element on the wafer side of a projection optical system may be filled with a liquid.

The number and shape of nozzles used in an embodiment are not particularly limited. For example, two pairs of nozzles may be used to supply and collect a liquid for the long side of the top part 4A. In this case, an emission nozzle and inflow nozzle may be disposed one above the other so that a liquid can be supplied or collected from any of the directions of +X and −X.

### Embodiment 2

Then, the liquid immersion exposure apparatus related to Embodiment 2 will be described. FIG. 6 is a front view showing the lower portion of the projection optical system PLA of the liquid immersion exposure apparatus using a step-and-scan method related to Embodiment 2, the liquid supply equipment 5, and the liquid collection equipment 6. In the following description, the XYZ rectangular coordinate system shown in FIG. 6 is set to describe the positional relationship of each part while referring to this XYZ rectangular coordinate system. In this XYZ rectangular coordinate system, X and Y axes are set to locate parallel to a substrate (wafer) W, and Z axis is set to locate orthogonally to the wafer W. The XYZ coordinate system described in the figure includes the XY plane parallel to a horizontal plane, and the Z axis running along the vertical direction in the real world. In FIG. 6, unless otherwise clearly noted, the same symbols as those used in Embodiment 1 are assigned to the same compositions in the liquid immersion exposure apparatus related to Embodiment 2 as those in the liquid immersion exposure apparatus related to Embodiment 2 in description.

In the liquid immersion exposure apparatus, the optical element 32 in the lowermost part of the mirror cylinder 3A of the projection optical system PLA is trimmed into a rectangular shape which is elongated in the direction of Y (non-scanning direction) by leaving only a part which the top part 32A on the wafer W side requires for scanning exposure. During scanning exposure, a part of the pattern images of the reticle (not shown in the figure) is projected on the wafer-side rectangular exposure region immediately beneath the top part 32A. At the same time, the wafer W moves at the speed of β·V (β is a projection magnification) in the direction of +X (or −X direction) via the XY stage 10 in synchronization with the reticle (not shown in the figure) moving at a rate of V in the direction of −X (or +X direction) relative to the projection optical system PLA. Then, after completion of exposure on one shot region, the next shot region is moved to a scanning starting position by stepping of the wafer W. A series of exposure to each shot region follows sequentially in the step-and-scan method.

In Embodiment 2, the same optical element (a preferred embodiment of the optical element of the present invention) as the optical element 4 (refer to FIG. 2) used in Embodiment 1 is used as the optical element 32.

A tantalum (Ta) film F5 (F4) is formed as a metallic dissolution preventing film (that also serves as a film to strengthen adherence) by a spattering method on the tapered surface 32B of the optical element 32, which is the region where no exposure light penetrates. A silicon dioxide (SiO₂) film F6 is formed by a wet film formation method to serve as a protective film for a metallic dissolution preventing film (dissolution-preventing-film-protecting film) for protecting the metallic dissolution preventing film on the surface of the metallic dissolution preventing film (dissolution preventing film) F5. With the first antireflection film formed on the top part 32A of the optical element 32, an average reflectance of the optical element 32 becomes 2% or less at the interface with a liquid when the exit angle of exposure light is between 0° and 70°.

Since Embodiment 2 is a liquid immersion exposure apparatus like Embodiment 1, the gap between the optical element 32 and the surface of the wafer W is filled with the liquid 7 during scanning exposure. The liquid 7 is supplied and collected by the liquid supply equipment 5 and the liquid collection equipment 6, respectively.

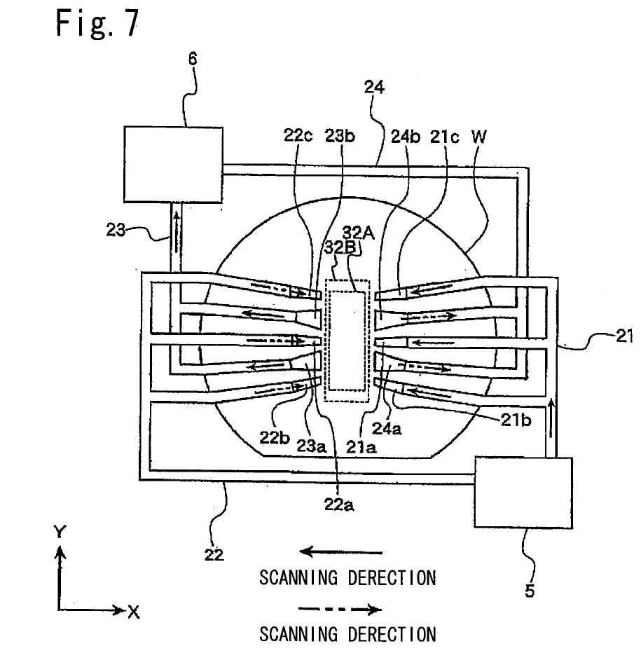

FIG. 7 shows the positional relationship among the surface of the optical element 32 (the wafer-side top part 32A and tapered surface 32B) of the projection optical system PLA, and emission nozzles for supplying the liquid 7 and inflow nozzles for collecting the liquid 7 in the direction of X. As shown in FIG. 7, three emission nozzles 21a, 21b and 21c, and three emission nozzles 22a, 22b, and 22c are connected to the liquid supply equipment 5 via the supply pipe 21 on the direction +X side and direction −X side, respectively, of the top part 32A which are in a rectangular shape elongated in the direction of Y and the tapered surface 32B. As shown in FIG. 7, two inflow nozzles 23a and 23b are connected to the liquid collection equipment 6 via the collection pipe 23 on the direction −X side of the top part 32A and the tapered surface 32B, and two inflow nozzles 24a and 24b are connected to the liquid collection equipment 6 via the collection pipe 24 on the direction +X side of the top part 32A and the tapered surface 32B.

When scanning exposure is performed by moving the wafer W in the scanning direction (−X direction) indicated by a solid arrow, the liquid supply equipment 5 supplies the liquid 7 via the supply pipe 21 and emission nozzles 21a, 21b and 21c to the gap among the top part 32A and tapered surface 32B of the optical element 32 and the wafer W. The liquid collection equipment 6 collects the liquid 7, which was supplied by the liquid supply equipment 5 to the gap among the top part 32A, the tapered surface 32B, and the wafer W, via the collection pipe 23 and the inflow nozzles 23a and 23b. In this case, the liquid 7 flows on the wafer W in the direction of −X, and the gap between the optical element 32 and the wafer W is filled with the liquid 7.

When scanning exposure is performed by moving the wafer W in the direction indicated by a double-dashed arrow (direction of +X), the liquid supply equipment 5 supplies the liquid 7 via the supply pipe 22 and emission nozzle 22a, 22b, and 22c to the gap between the top part 32A of the optical element 32 and the wafer W. The liquid collection equipment 6 collects the liquid 7, which was supplied by the liquid supply equipment 5 to the gap between the top part 32A and the wafer W, via the collection pipe 24 and the inflow nozzle 24a and 24b. In this case, the liquid 7 flows on the wafer W in the direction of +X. The gap between the optical element 32 and the wafer W is filled with the liquid 7.

The supplied amount Vi (m³/s) and collected amount Vo (m³/s) of the liquid 7 are calculated using the following mathematical formula 4.

Vi=Vo=DSY·v·d (Mathematical Formula 4)

In this formula, DSY is the length of the top part 32A of the optical element 32 in the direction of X (m). Since DSY is previously input, the liquid 7 is stably filled in the gap between the optical element 32 and wafer W even during scanning exposure by calculating and controlling the supplied amount Vi (m³/s) and collected amount Vo (m³/s) of the liquid 7 are calculated based on the mathematical formula 3.

When the wafer W is stepwisely moved in the direction of Y, the liquid 7 is supplied and collected from the direction of Y by the same method as that of Embodiment 1.

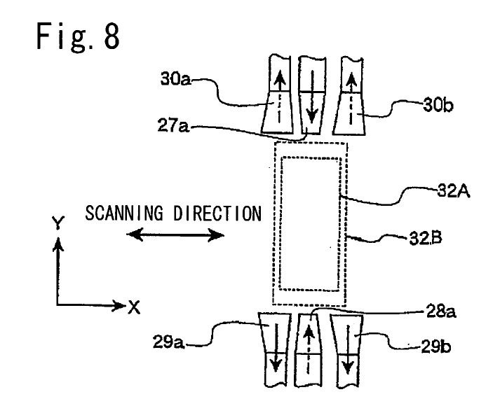

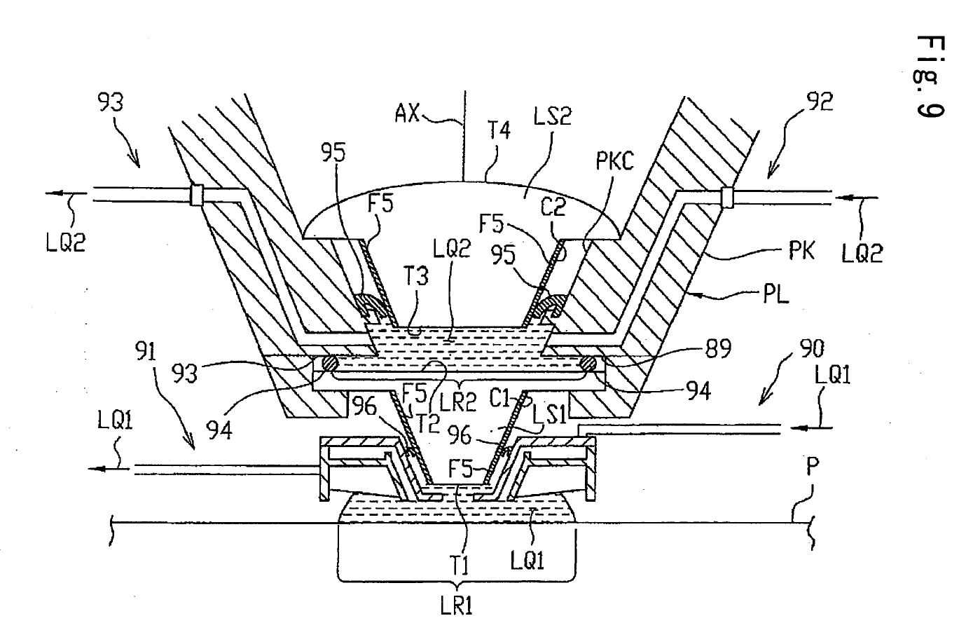

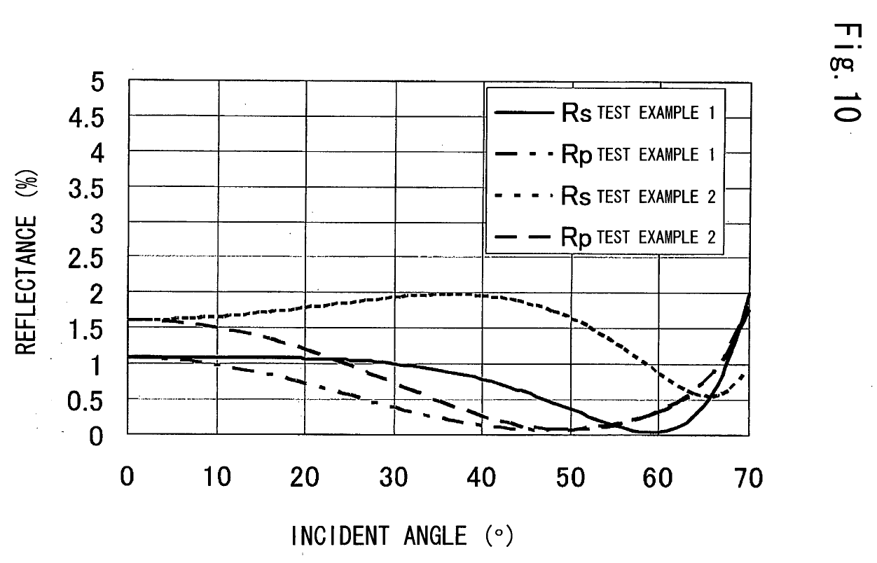

FIG. 8 shows the positional relationship between the top part 32A of the optical element 32 of the projection optical system PLA, the emission and inflow nozzles for the direction Y. As shown in FIG. 8, when the wafer W is stepwisely moved in a non-scanning direction perpendicular to a scanning direction (−Y direction), the emission nozzle 27a and inflow nozzles 29a and 29b arranged in the direction of Y are used to supply and collect the liquid 7. When the wafer is stepwisely moved in the direction of +Y, the emission nozzle 28a and inflow nozzles 30a and 30b arranged in the direction of Y are used to supply and collect the liquid 7. In this case, the supplied amount Vi (m³/s) and collected amount Vo (m³/s) of the liquid 7 are calculated using the following mathematical formula 5.

Vi=Vo=DSX·v·d (Mathematical Formula 5)

In this formula, DSX is the length in the direction of Y (m) of the top part 32A of the optical element 32. As in Embodiment 1, even when the wafer W is stepwisely moved in the direction of Y, the gap between the optical element 32 and the wafer W is continuously filled by the liquid 7 by controlling the supplied amount of the liquid 7 according to a migration speed of v.

According to such liquid immersion exposure apparatus related to Embodiment 2, the same actions and effects as in Embodiment 1 are achieved.

With the liquid immersion exposure apparatus related to Embodiment 2, a metallic dissolution preventing film can be attached closely to the optical element 32, since a metallic dissolution preventing film, which also serves as a film to strengthen adherence, has been formed on the tapered surface 32B of the optical element 32 on the wafer W side of the projection optical system PLA. Furthermore, since a silicon dioxide film (SiO₂) has been formed on the surface of the metallic dissolution preventing film, it is possible to protect the metallic dissolution preventing film by preventing any damage on the film which is soft and has a low abrasion resistance.

### Embodiment 3

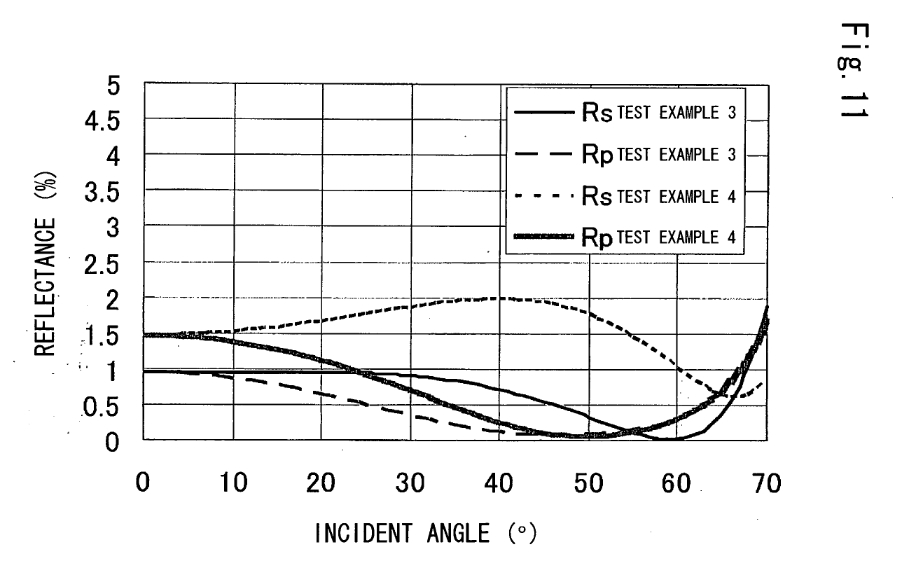

The liquid immersion exposure apparatus related to Embodiment 3 will then be described. FIG. 9 shows some of a plurality of optical elements constructing the projection optical system PL of the liquid immersion exposure apparatus related to Embodiment 3, such as a first optical element LS1, which is the closest optical element to the image plane of the projection optical system PL, and the second optical element LS2, which is the second closest one after the first optical element LS1 to the image plane of the projection optical system PL.

The liquid immersion exposure apparatus includes the first liquid immersion mechanism to fill the gap between the bottom surface T1 of the first optical element LS1, which is the closest element to the image plane of the projection optical system PL among a plurality of optical elements constructing the projection optical system PL, and a substrate P with the first liquid LQ1. The substrate P is mounted on the image plane side of the projection optical system PL. The bottom surface T1 of the first optical element LS1 is disposed such as to face to the surface of the substrate P. The first liquid immersion system has the first liquid supply system 90 which supplies the first liquid LQ1 to the gap between the bottom surface T1 of the first optical element LS1 and the substrate P, and the first liquid collection system 91 which collects the first liquid LQ1 supplied by the first liquid supply system 90.

The liquid immersion exposure apparatus includes the second liquid immersion system to fill the gap between the first optical element LS1 and the second optical element LS2, which is the second closest element after the first optical element LS1 to the image plane of the projection optical system PL, with the second liquid LQ2. The second optical element LS2 is disposed above the first optical element LS1. The top surface T2 of the first optical element LS1 is disposed so as to face the bottom surface T3 of the second optical element LS2. The second liquid immersion system includes the second liquid supply system 92, which supplies the second liquid LQ2 to the gap between the first optical element LS1 and the second optical element LS2, and the second liquid collection system 93, which collects the second liquid LQ2 supplied by the second liquid supply system 92.

Furthermore, the first antireflection film is formed on the bottom surface T1 and the top surface T2 of the first optical element LS1, and the bottom surface T3 of the second optical element LS2. The first optical element LS1 and the second optical element LS2 each are consisted of the optical element of the present invention.

An opposed surface 89 which faces to the peripheral region of the top surface T2 of the first optical element LS1 is mounted on a mirror cylinder PK. A first seal member 94 is mounted between the peripheral region of the top surface T2 and the opposed surface 89. The first seal member 94 is constructed of, for example, an O-ring (for example, “Kalrez” manufactured by DuPont Dow Elastomers) or a C-ring. The first seal member 94 prevents the second liquid LQ2 disposed on the top surface T2 from leaking out of the top surface T2, and consequently from leaking out of the mirror cylinder PK. A second seal member 95 is also mounted between the side surface C2 of the second optical element LS2 and the internal surface PCK of the mirror cylinder PK. The second seal member 95 is constructed of, for example, a V-ring. The second seal member 95 regulates the second liquid LQ2 and wet gas generating from the second liquid LQ2 from going through above the second optical element LS2 inside the mirror cylinder PK.

A third seal member 96 is mounted between the side surface C1 of the first optical element LS1 and the internal surface PKC of the mirror cylinder PK. The third seal member 96 is constructed of, for example, a V-ring. The third seal member 96 regulates the first liquid LQ1 and wet gas generating from the first liquid LQ1 from going through above the first optical element LS1 inside the mirror cylinder PK.

A light shielding film which is a gold (Au) film with a thickness of 150 nm and a liquid repellent film are formed on the side surface C1 (tapered surface) of the first optical element LS1, and the side surface C2 (tapered surface) of the second optical element LS2. Such a light shielding film can prevent exposure light and the reflected light of the exposure light from a wafer from illuminating the first seal member 94, the second seal member 95, and the third seal member 96, which are mounted in a peripheral part of the tapered surface of the optical element on the substrate side in the projection optical system; thus, it becomes possible to prevent the seal members from being deteriorated. The above-mentioned liquid repellent film can achieve better adhesion of a liquid to the bottom surface T1 of the first optical element LS1 and the bottom surface T3 of the second optical element LS2.

In the liquid immersion exposure apparatus, the pattern image of a mask M is applied to projection exposure on a substrate P while the mask M and the substrate P are moving in a scanning direction (X-axis direction: the direction indicated by an arrow LQ1 in FIG. 9). During scanning exposure, a part of the pattern image of the mask M is projected in a projection region via the projection optical system PL, and the first and second liquids LQ1 and LQ2 of the first and second liquid immersion regions LR1 and LR2. The substrate P moves at a speed of β·v (β is a projection magnification) in the direction of +X (or −X direction) in the projection region in synchronization with the movement of the mask M in the direction of −X (or +X direction) at a speed of V. A plurality of shot regions are set on the substrate P. After the completion of exposure on one shot region, the next shot region is moved to a scanning starting region by stepping of the substrate P. A series of scanning exposure treatments to each shot region follows sequentially while moving the substrate P by the step-and-scan method. Various controls in the exposure treatment in the apparatus, such as the control of the amount of a liquid supplied, can be carried out by employing the same method as those in the above-mentioned Embodiments 1 and 2.

The liquid immersion exposure apparatuses of the above-mentioned Embodiments 1 to 3 are produced by fabricating various kinds of subsystems including each component upon maintaining predetermined mechanical, electrical, and optical accuracies. In order to maintain these accuracies, an adjustment to achieve optical accuracy for various optical systems, an adjustment to achieve mechanical accuracy for various mechanical systems, an adjustment to achieve electrical accuracy for various electrical systems are performed before and after the fabrication.

A process of fabricating the exposure apparatus with various subsystems includes mechanical connections among various subsystems, wiring connections among electrical circuits, and piping connections among barometric circuits. Needless to say, there is a fabrication process of each subsystem before a process of fabricating the exposure apparatus with these subsystems. After the completion of the process of fabricating the exposure apparatus with various kinds of the subsystems, a comprehensive adjustment is conducted to secure various accuracies in the whole exposure apparatus. The production of the exposure apparatus is preferably conducted in a clean room where conditions, such as the temperature and cleanliness, are controlled.

In the above-mentioned Embodiments 1 to 3, an exposure apparatus in which a part of a gap between the projection optical system PL and the substrate P is filled with a liquid is employed. The present invention can be applied to a liquid immersion exposure apparatus disclosed in Japanese Unexamined Patent Application Publication No. Hei 6-124873 in which a stage holding a substrate to be exposed is moved in a liquid tank, and to a liquid immersion exposure apparatus disclosed in Japanese Unexamined Patent Application Publication No. Hei 10-303114 in which a substrate is held in a liquid tank with a predetermined depth which is formed on a stage.

In Embodiments 1 to 3, an exposure apparatus in which a part of a gap between the projection optical system PL and the substrate P is filled with a liquid is employed. The present invention can also be applied to a liquid immersion exposure apparatus disclosed in JP 6-124873, JP 10-303114, and U.S. Pat. No. 5,825,043, in which exposure is performed in a condition where the entire surface of a substrate to be exposed is immersed in a liquid.

Furthermore, in Embodiments 1 to 3, an exposure apparatus including a single substrate stage was used to describe the embodiments. The liquid immersion exposure apparatus of the present invention may be applied to a multi-stage (twin-stage) type of an exposure apparatus in which two substrate stages move on an exposure station and a measurement station. Therefore, the present invention can be applied to a twin-stage type of an exposure apparatus which includes two stages which are independently movable in the directions of X and Y while each is mounted with substrates to be processed, such as a wafer, disclosed in Japanese Unexamined Patent Application Publication No. Hei 10-163099, Japanese Unexamined Patent Application Publication No. Hei 10-214783, and International Application Japanese-Phase Publication No. 2000-505958.

The multi-stage type of an exposure apparatus is also disclosed in U.S. Pat. Nos. 6,341,007, 6,400,441, 6,549,269, 6,590,634, and 5969441. These US patents are incorporated herein, and are considered to be a part of the present description. The present invention can also be applied to an exposure apparatus including a substrate stage holding a substrate and a measurement stage which includes a standard member in which a standard mark is formed and/or various photoelectronic sensors, as disclosed in, for example, International Publication No. 1999/23692 and U.S. Pat. No. 6,897,963. Furthermore, U.S. Pat. No. 6,897,963 is incorporated to be considered to be a part of the present description.

International Publication Nos. WO2004/019128, WO2004/053950, WO2004/053951, and WO2005/122220 in which a construction applicable to the liquid immersion exposure apparatus of the present invention is described are also incorporated herein as a reference.

Furthermore, Embodiments 1 to 3 have been described above by taking a liquid immersion exposure apparatus including a projection optical system for example. The present invention can be applied to an exposure apparatus and an exposure method which do not use a projection optical system PL. Even in a case where no projection optical system is used, exposure light is illuminated on a substrate via an optical element, and, furthermore, a liquid immersion region is formed in the gap between the optical element and the substrate.

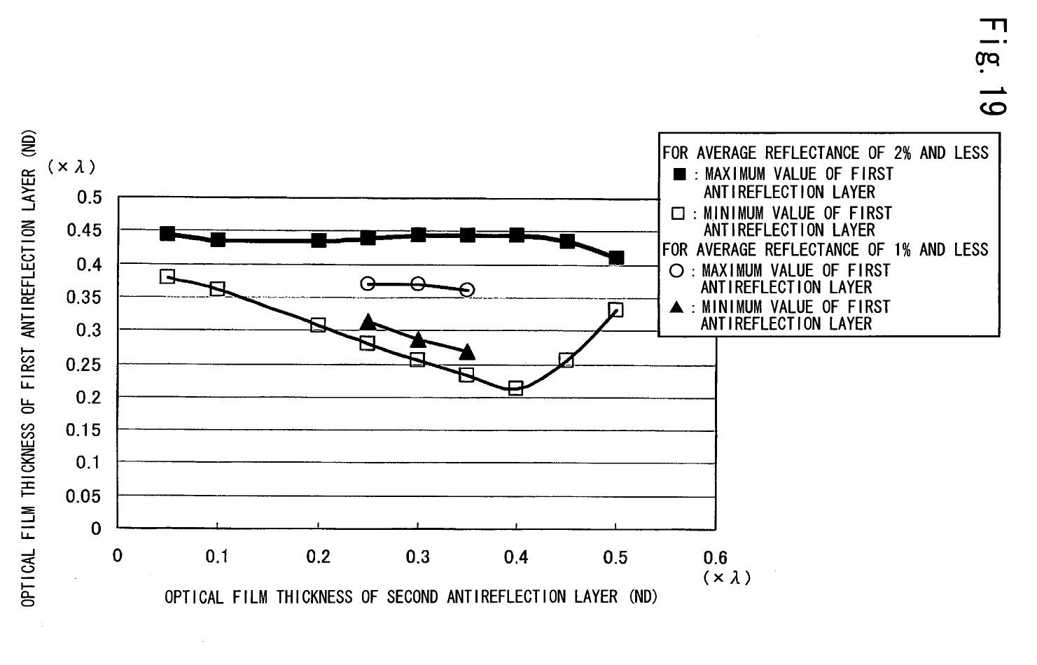

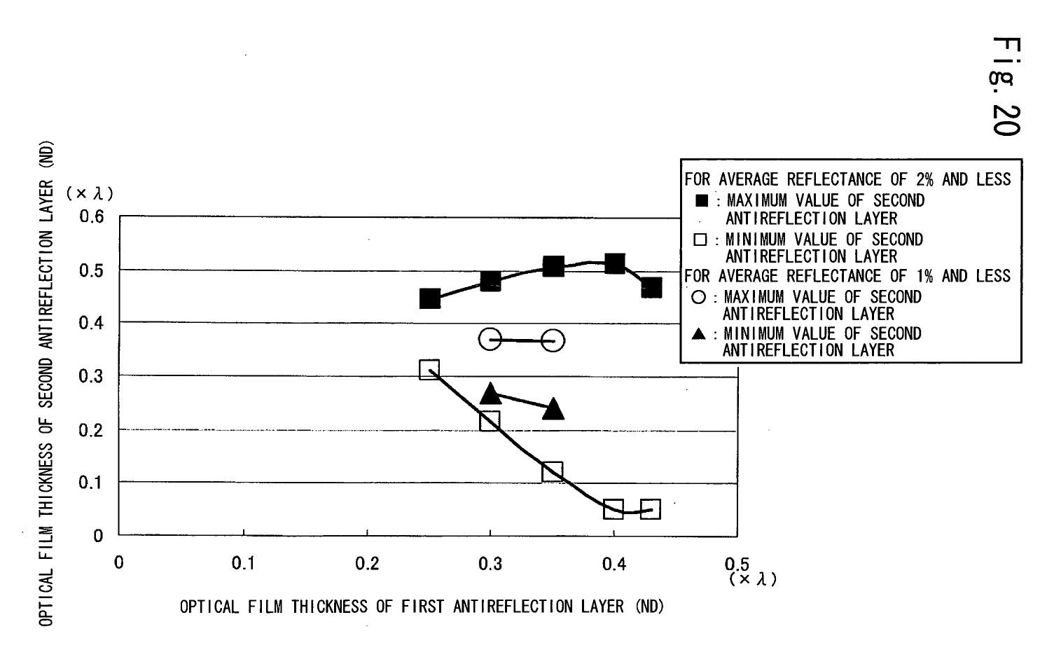

The present invention can also be applied to an exposure apparatus which exposes a photosensitive substrate to a pattern using a plurality of diffraction gratings, as disclosed in International Publication No. 2006/64900, for example. In detail, it is possible to mount the light shielding film and the liquid repellent film described in the above-mentioned Embodiment on at least one of translucent plates P1 and P2 including a diffraction grating formed therein, which are shown in FIGS. 18 and 19 in International Publication No. 2006/64900.

It is also possible to apply the present invention to an exposure apparatus for exposing a substrate to a line-and-space pattern on the substrate by forming interference fringes on the substrate, as disclosed in International Publication Pamphlet No. 2001/035168, for example, and an exposure apparatus in which one shot region on a substrate is doubly exposed at almost simultaneously in one scanning exposure by combining patterns of two masks via a projection optical system on the substrate as disclosed in International Patent Application Japanese-Phase Publication No. 2004-519850 (Equivalent U.S. Pat. No. 6,611,316), for example.

In the above-mentioned Embodiments 1 to 3, an optically-transparent-type mask produced by forming a certain light-shielding pattern (or phase pattern, a light reducing pattern) on an optically-transparent substrate is used. As disclosed in, for example, U.S. Pat. No. 6,778,257, an electronic mask (which is also called a variable shaped mask, and includes DMD (Digital Micro-mirror Device) which is a kind of a non-emission-type image display element (spatial light modulator), for example) for forming a transmission pattern, a reflection pattern, or an emission pattern, based on electronic data of a pattern to be formed on a substrate to be exposed may also be used in the place of the mask described in Embodiments 1 to 3.

The liquid immersion exposure apparatus of the present invention can be applied widely as an exposure apparatus for producing liquid crystal display elements, an exposure apparatus for producing displays, as an exposure apparatus for producing thin film magnetic heads, image devices (CCD), micro machines, MEMS, and DNA chip, in addition to being used as an exposure apparatus for producing micro devices, such as a semiconductor element which exposes a substrate to a semiconductor element pattern.

The liquid immersion exposure apparatus of the present invention can also be applied as an exposure apparatus for transferring a circuit patter from a mother reticle to a glass substrate or a silicon wafer to produce a reticle or a mask used in several apparatuses, such as a light exposure apparatus, an EUV exposure apparatus, an X-ray exposure apparatus, and an electron beam exposure apparatus. In an exposure apparatus using DUV light (deep ultraviolet light) or VUV light (vacuum ultraviolet light) a transmission type reticle is commonly used, and the selection of reticle substrates used therein include silica glass, a silica glass doped with fluorine, calcium fluorite, magnesium fluoride, and quartz. In an X-ray exposure apparatus based on a proximity method and an electron beam exposure apparatus, a transmission type mask (stencil mask, membrane mask) is used, the selection of mask substrates used includes a silicon wafer and the like.

The disclosures of all Japanese Unexamined Patent Application Publications and US patents about an exposure apparatus quoted in each above-mentioned Embodiment and above-mentioned modification are incorporated herein by reference, and are considered to be a part of the present description.

The preferred embodiments of the exposure apparatus of the present invention and the liquid immersion exposure method of the present invention using the exposure apparatus have been described above. A preferred embodiment of a micro device production method of the present invention will be described below.

The micro device production method of the present invention includes a process of exposing a substrate by exposure light illuminated on the substrate via a liquid using the liquid immersion exposure apparatus of the present invention. In other words, a production method of micro devices, such as a semiconductor device, utilizes the above-mentioned exposure apparatus and liquid immersion exposure method to produce micro devices (for example, a semiconductor element, an image device (CCD and the like), a crystal display element, and a thin film magnetic head). Such a production method of micro devices can include the following processes, for example: a process of designing functions and performance of a micro device, a process of producing a mask based on the obtained design, a process of producing a substrate which serves as a base material of the micro device, a process of exposing the substrate to the pattern of the mask by exposure light illuminated on the substrate via a liquid using the above-mentioned exposure apparatus of the present invention, a process of fabricating the device (including a dicing process, a bonding process, and a packaging process), and a process of inspecting the fabricated device. For these processes except for the process of exposing the substrate using the above-mentioned exposure apparatus of the present invention, any methods available in the public domain can be used accordingly.

### EXAMPLES

### Test Examples 1 to 18

In these test examples, a single crystal of Lu₃Al₅O₁₂ (garnet material: LuAG) is used as a base material of an optical element. In a case where the first antireflection film is formed on one surface of the base material by forming the first antireflection layer with an optical film thickness described in Table 1 on the surface of the base material, and the second antireflection layer with an optical film thickness described in Table 1 on the surface of the first antireflection layer, and where the optical element is disposed such that the obtained first antireflection film of each optical element is in contact with decalin (with a reflectance of 1.64 to the light with a wavelength of 193 nm), the reflectance of the optical element is as shown in FIGS. 10 to 18 at the interface between decalin and the first antireflection film while varying the incidence angle of an incident light with a wavelength of 193 nm coming in from the contact surface between an optical element and gas from 0° to 70° for. The reflectance was determined by calculation using the optical film thickness and the reflectance as parameters. The first antireflection layer can be made by a vacuum deposition method from an aluminum oxide (Al₂O₃). The second antireflection layer can be made by a vacuum deposition method from a lanthanum fluoride (LaF₃). In each test example, the above-mentioned base material has a refraction index of 2.14 to the light with a wavelength of 193 nm. The refraction index of the first antireflection layer is to be adjusted to 1.84, and the refraction index of the second antireflection layer is to be adjusted to 1.70. For the measurement, U4100 spectrophotometer manufactured by Hitachi High-Technologies Corporation can be used.

TABLE 1

| | First antireflection film | |
|---|---|---|
| | First antireflection layer | |
| | (Al₂O₃ layer) | Second antireflection layer |
| | Refraction index 1.84 | (LaF₃ layer) |
| | (Illuminated | Refraction index 1.70 |
| | light: 193 nm) Optical | (Illuminated light: 193 nm) |
| | film thickness (nd) | Optical film thickness (nd) |
| Test example 1 | 0.378λ | 0.050λ |
| Test example 2 | 0.443λ | 0.050λ |
| Test example 3 | 0.360λ | 0.100λ |
| Test example 4 | 0.436λ | 0.100λ |
| Test example 5 | 0.307λ | 0.200λ |
| Test example 6 | 0.436λ | 0.200λ |
| Test example 7 | 0.255λ | 0.300λ |
| Test example 8 | 0.443λ | 0.300λ |
| Test example 9 | 0.213λ | 0.400λ |
| Test example 10 | 0.443λ | 0.400λ |
| Test example 11 | 0.332λ | 0.500λ |
| Test example 12 | 0.410λ | 0.500λ |
| Test example 13 | 0.250λ | 0.311λ |
| Test example 14 | 0.250λ | 0.445λ |
| Test example 15 | 0.300λ | 0.217λ |
| Test example 16 | 0.300λ | 0.480λ |
| Test example 17 | 0.400λ | 0.050λ |
| Test example 18 | 0.400λ | 0.513λ |

In FIGS. 10 to 18, the object (optical element) of the graph shown in each Figure is as follows:

FIG. 10: Test examples 1 and 2 (The optical film thickness of the second antireflection layer is 0.050λ in both tests.)

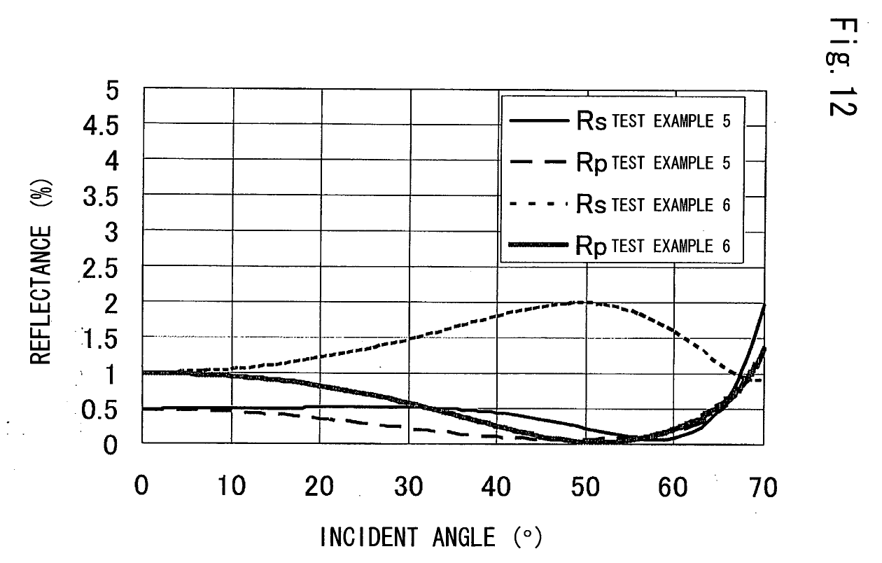

FIG. 11: Test examples 3 and 4 (The optical film thickness of the second antireflection layer is 0.100λ in both tests.)

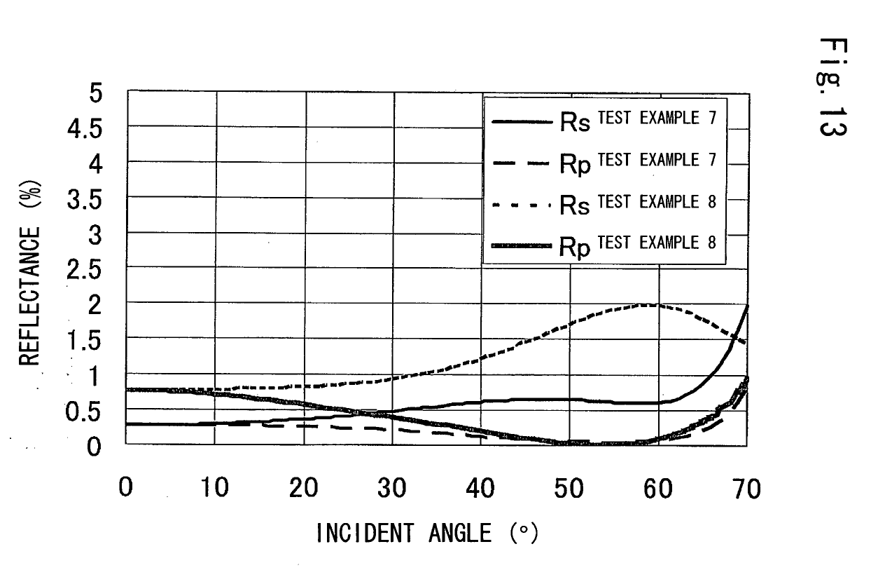

FIG. 12: Test examples 5 and 6 (The optical film thickness of the second antireflection layer is 0.200λ in both tests.)

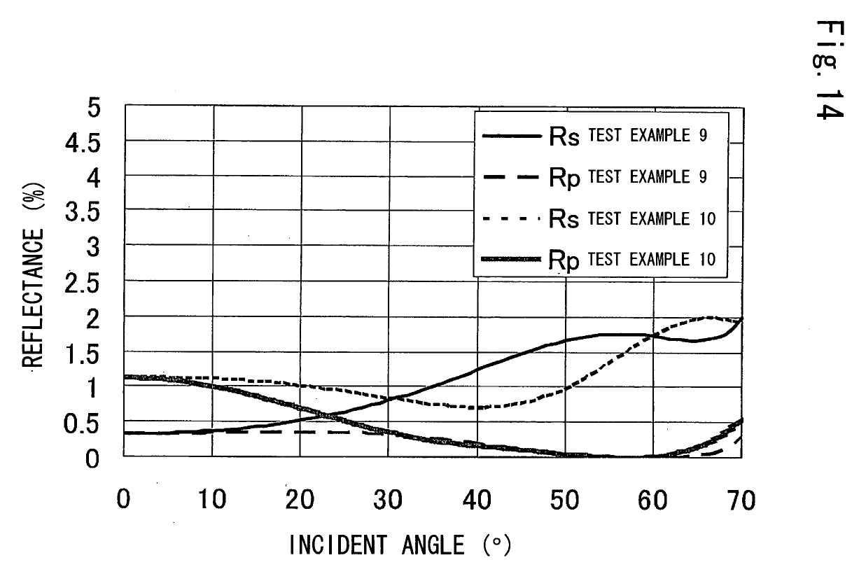

FIG. 13: Test examples 7 and 8 (The optical film thickness of the second antireflection layer is 0.300λ in both tests.)

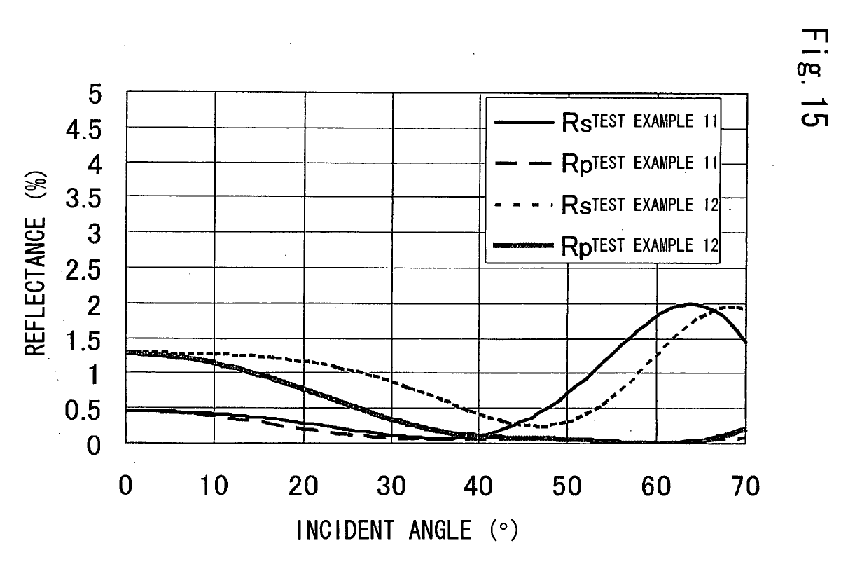

FIG. 14: Test examples 9 and 10 (The optical film thickness of the second antireflection layer is 0.400λ in both tests.)

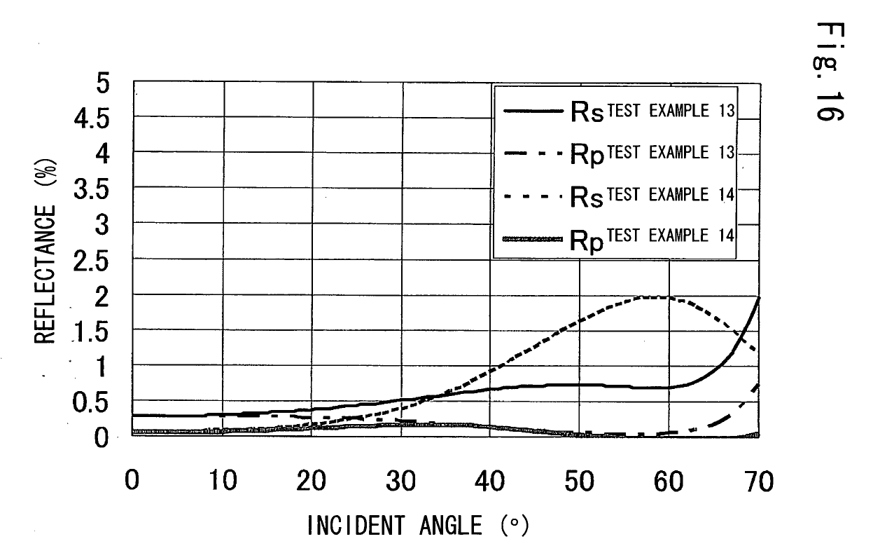

FIG. 15: Test examples 11 and 12 (The optical film thickness of the second antireflection layer is 0.500λ in both tests.)

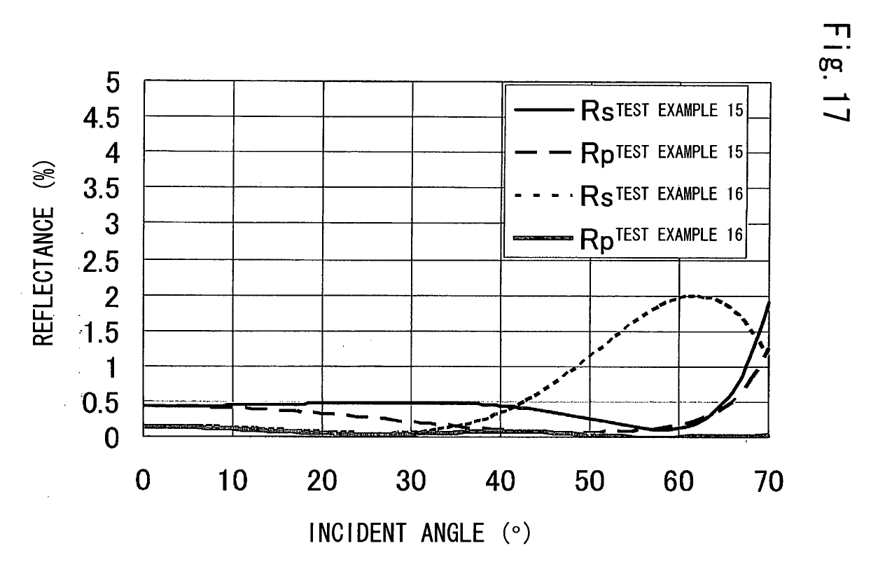

FIG. 16: Test examples 13 and 14 (The optical film thickness of the first antireflection layer is 0.250λ in both tests.)

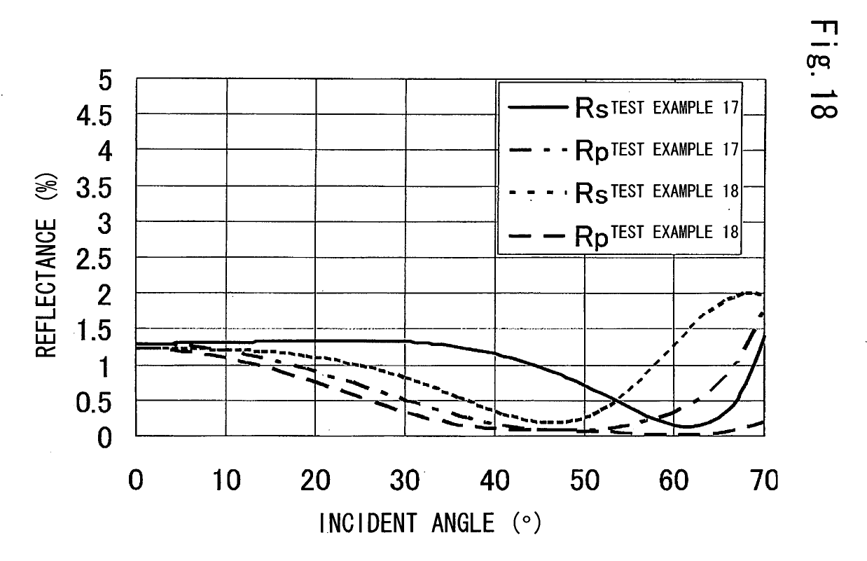

FIG. 17: Test examples 15 and 16 (The optical film thickness of the first antireflection layer is 0.300λ in both tests.)

FIG. 18: Test examples 17 and 18 (The optical film thickness of the first antireflection layer is 0.400λ in both tests.)

In a case where the first antireflection layer optical film thickness (nd) is varied while fixing the optical film thickness (nd) of the second antireflection layer to 0.05λ, 0.10λ, 0.20λ, 0.30λ, 0.40λ, and 0.50λeach, the maximum and minimum values of the optical film thickness (nd) of the first antireflection layer which allows the optical element to achieve an average reflectance of 2% or less and 1% or less to the light with a wavelength of 193 nm for each second antireflection layer with the above-mentioned optical film thicknesses are as shown in FIG. 19. In the same way, in a case where the optical film thickness of the second antireflection layer is varied while fixing the optical film thickness of the first antireflection layer (nd) to 0.25λ, 0.30λ, and 0.40λ each, the maximum and minimum values of the optical film thickness (nd) of the second antireflection layer which allows the optical element to achieve an average reflectance of 2% or less and 1% or less to the light with a wavelength of 193 nm for each first antireflection layer with the above-mentioned optical film thicknesses are as shown in FIG. 20.

The graphs described in the FIGS. 10 to 20 allow to understand that it is possible to achieve an average reflectance of the optical element of 2% or less to the light with a wavelength of 193 nm of which incidence angle ranges from 0° to 70° by setting an optical film thickness (nd) of the first antireflection layer to be in a range between 0.25λ and 0.42λ to the wavelength λ of the incidence light, and an optical film thickness (nd) of the second antireflection layer to be in a range between 0.1λ and 0.45λ to the wavelength λ of the incidence light. It is also understood that it is possible to achieve an average reflectance of the optical element of 1% or less to the light with a wavelength of 193 nm of which incidence angle ranges from 0° to 70° by setting an optical film thickness (nd) of the first antireflection layer to be in a range between 0.30λ and 0.35λ to the wavelength λ of the incidence light, and an optical film thickness (nd) of the second antireflection layer to be in a range between 0.24λ and 0.375λ to the wavelength λ of the incidence light. Each range of the optical film thickness (nd) of the first and second antireflection layers which allows an average reflectance to achieve 1% or less can be derived from the graphs shown in FIGS. 19 and 20. According to the graphs described in FIGS. 19 and 20, it is also understood that, in a case where the optical film thickness of the second antireflection layer is in a range between 0.1λ and 0.3λ, the average reflectance of the optical element can be 2% or less, if the optical film thickness of the first antireflection layer and the optical film thickness of the second antireflection layer do not satisfy the relationship expressed in the above-mentioned mathematical formula 1 (Y<−0.53x+0.41: Y is the optical thickness of the first antireflection layer, and X is the optical thickness of the first antireflection layer). Hence, in a liquid immersion exposure apparatus using the optical element of Embodiments of the present invention, it is possible to perform lithography with a sufficiently high level of resolution even when a liquid with a high refraction index is used.

As described above, according to Embodiments of the present invention, it is possible to provide an optical element which can exhibit excellent antireflective properties with an average reflectance of 2% or less to the light with a wavelength of 193 nm within an incidence angle range of 0° to 70° at the interface with a liquid, while using a base material with a high refraction index and a liquid with a high refraction index, a liquid immersion exposure apparatus using the optical element, a liquid immersion exposure method using the liquid immersion exposure apparatus, and a micro device production method using the liquid immersion exposure apparatus.

Hence, with the particularly excellent antireflective properties, the optical element of the present invention becomes highly useful as an optical element in a liquid immersion exposure apparatus employing a liquid immersion method using a liquid with a high refraction index.

The present invention has been described above using several Embodiments and Test examples mentioned above. The present invention can also be applied to other embodiments and test examples, which can be devised without deviating from the scope of the present invention. Hence, the scope of the present invention should be limited only by the appended claims.

What is claimed is:

1. An optical element used such that at least one surface thereof is in contact with a liquid in a liquid immersion exposure apparatus in which a substrate is exposed by exposure light illuminated on the substrate via the liquid with a refraction index in a range between 1.60 and 1.66 to the light with a wavelength of 193 nm, comprising:
a base material with a refraction index in a range between 2.10 and 2.30 to the light with a wavelength of 193 nm; and
a first antireflection film formed on the contact surface between the base material and the liquid,
wherein the first antireflection film includes a first antireflection layer with a refraction index in a range between 1.80 and 2.02 to the light with a wavelength of 193 nm and an optical film thickness in a range between 0.25λ and 0.42λ to the wavelength λ of the exposure light,
a second antireflection layer with a refraction index in a range between 1.65 and 1.77 to the light with a wavelength of 193 nm and an optical film thickness in a range between 0.10λ and 0.45λ to the wavelength λ of the exposure light, and
the first antireflection layer and the second antireflection layer are sequentially laminated in an order from the base material side.

2. The optical element according to claim 1, wherein the first antireflection layer has the optical film thickness in a range between 0.30λ and 0.35λ, and the second antireflection layer has the optical film thickness in a range between 0.24λ and 0.375λ.

3. The optical element according to claim 1, wherein the first antireflection layer has an physical film thickness in a range between 31 nm and 37 nm, and wherein the second antireflection layer has an physical film thickness in a range between 27 nm and 43 nm.

4. The optical element according to claim 1, wherein the optical element exhibits an average reflectance of 2.0% or less to the light with a wavelength of 193 nm within an incidence angle range of 0° to 70° at the interface between the liquid and the first antireflection film.

5. The optical element according to claim 1, wherein the optical element exhibits an average reflectance of 1.0% or less to the light with a wavelength of 193 nm within an incidence angle range of 0° to 70° at the interface between the liquid and the first antireflection film.

6. The optical element according to claim 1, wherein the first antireflection layer contains a metal oxide selected from the group consisting of aluminum oxide, gadolinium oxide, and scandium oxide.

7. The optical element according to claim 1, wherein the second antireflection layer contains a metal fluoride selected from the group consisting of lanthanum fluoride, gadolinium fluoride, neodymium fluoride, hafnium fluoride, lutetium fluoride, yttrium fluoride, ytterbium fluoride, and dysprosium fluoride.

8. The optical element according to claim 1, wherein the base material contains a material for the base material selected from the group consisting of garnet and spinel ceramics.

9. The optical element according to claim 1, further comprising a second antireflection film on the surface of the base material being in contact with the gas, in a case where the base material has a surface being in contact with gas.

10. The optical element according to claim 9, wherein the optical element has an average reflectance of 1.0% or less to the light with a wavelength of 193 nm within an incidence angle range of 0 to 40° at the interface between the gas and the second antireflection film.

11. The optical element according to claim 9, wherein the optical element has an average reflectance of 0.5% or less to the light with a wavelength of 193 nm within an incidence angle range of 0° to 40° at the interface between the gas and the second antireflection film.

12. A liquid immersion exposure apparatus illuminating exposure light on a substrate via an optical element and a liquid which fills the region between at least one of the optical element and a substrate, which and has a refraction index in a range between 1.60 and 1.66 to the light with a wavelength of 193 nm, wherein an optical element used such as to have contact with the liquid is the optical element according to claim 1.

13. A liquid immersion exposure method which includes a process of exposing a substrate by exposure light illuminated on the substrate via a liquid by using the liquid immersion exposure apparatus according to claim 12.

14. A micro device production method which includes a process of exposing a substrate by exposure light illuminated on the substrate via a liquid by using the liquid immersion exposure apparatus according to claim 12.
